(19) United States
(12) Patent Application Publication
(10) Pub. No.: US 2017/0179596 A1
(43) Pub. Date: Jun. 22, 2017

(54) WIDEBAND REFLECTARRAY ANTENNA FOR DUAL POLARIZATION APPLICATIONS

(71) Applicant: AGENCE SPATIALE EUROPEENNE, Paris Cedex 15 (FR)

(72) Inventors: Rafael Florencio Diaz, Seville (ES); Jose' Antonio Encinar Garcinuno, Madrid (ES); Rafael Rodriguez Boix, Seville (ES); Giovanni Toso, Haarlem (NL)

(73) Assignee: AGENCE SPATIALE EUROPÉENNE, Paris (FR)

(21) Appl. No.: 15/305,015

(22) PCT Filed: Apr. 30, 2014
(86) PCT No.: PCT/IB2014/002265

§ 371 Date: Oct. 18, 2016

(51) Int. Cl. H01Q 3/46; H01Q 3/34; H01Q 1/28; H01Q 21/06; H01Q 21/24

(52) U.S. Cl. CPC H01Q 3/46; H01Q 21/062; H01Q 21/24; H01Q 1/288; H01Q 3/34

(57) ABSTRACT

A wideband reflectarray antenna for dual polarizations application is formed by an array of phasing cells, where each cell contains two orthogonal or quasi-orthogonal sets of parallel conductive dipoles printed on two levels of a multilayered grounded substrate. The dipoles for each polarization are coupled in both horizontal and vertical directions, providing a large broadband operation and low cross-polarization with only two levels of metallizations. The antenna is designed by adjusting the lengths of the dipoles to produce the phase-shift required to collimate or shape the radiated beam in dual-polarization when illuminated by a feed, either in broadband or dual-frequency operation. The invention also relates to a design and manufacturing method for producing the reflectarray antenna, based on the optimization of the dipole lengths for each phasing cell.

This invention is related to planar reflector antennas called “reflectarrays” working in dual-polarization and used mainly in the telecommunication, radar and space technology sectors.

The invention concerns a wideband dual-polarization reflectarray antenna wherein the phasing elements or phasing cells are designed and arranged in order to minimize the cross-polarization components generated by the antenna, and a method for producing such an antenna.

An important application of reflectarrays is their use as space antennas to provide a collimated or contoured beam in dual-polarization, as an alternative to the conventional onboard shaped reflectors. The design requirements of spacecraft antennas for satellite broadcast and telecommunication missions are becoming extremely stringent. In particular, they may include highly shaped contoured beams to efficiently illuminate the prescribed geographical area, dual-polarization for frequency reuse with very low levels of cross-polarization, co-polar isolation in other geographical regions to avoid interference with other coverage regions, and transmit-receive (Tx-Rx) operation. The use of a single transmit-receive antenna is very attractive because of the reduction in volume, mass and costs in the satellite pay-load. In dual-polarization antennas, independent signals are transmitted and received in orthogonal polarizations in the same frequency bands, which requires a very high isolation between polarizations. Although the two orthogonal polarizations can be circular, clockwise and counterclockwise, the most common case is to use two linear polarizations, which are designated as vertical (V) and horizontal (H). Currently, shaped reflectors are satisfactorily used in many missions to provide the requirements of coverage, cross-polarization and isolation in both transmit and receive frequency bands, which are separated more than 20% in Ku-band missions. However, the main disadvantage of reflector antennas is the manufacturing of a specific mold for the shaped reflector, which depends on the antenna requirements and therefore cannot be reused for other missions. These molds have an associated impact on the cost of the antenna and the manufacturing time. Reflectarray antennas are an attractive alternative to reflector antennas since they are made of a flat panel, and therefore, they do not require any mold to be manufactured. In addition, whereas only the dimensions of the printed elements have to be varied for a specific coverage, the structural panel can be kept. As a consequence of this, the mechanical models and tests can be reused for different antenna requirements.

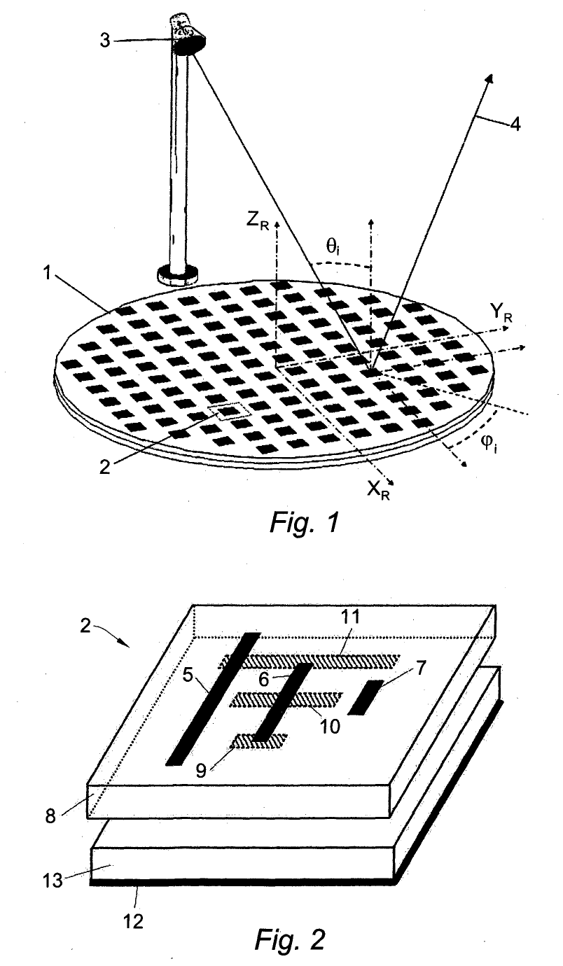

A reflectarray antenna [D. G. Berry, R. G. Malech, W. A. Kennedy, “The Reflectarray Antenna”, IEEE Trans. on Antennas and Propagat., Vol. AP-11, 1963, pp. 646-651] consists of a planar array of reflective elements with a certain adjustment in the phase of the reflected field to produce a collimated electromagnetic beam when it is illuminated by a primary feed (FIG. 1). A simple and low-cost implementation of the reflectarray antenna uses metallic elements printed on a single grounded dielectric layer, where the sizes of the elements are varied along the printed reflectarray to obtain the required adjustment of the reflected phase. Crossed dipoles [D. G. Gonzalez, G. E. Pollon, J. F. Walker, “Microwave phasing structures for electromagnetically emulating reflective surfaces and focusing elements of selected geometry”, U.S. Pat. No. 4,905,014, February 1990] and rectangular metallic patches [D. M. Pozar and T. A. Metzler, “Analysis of a reflectarray antenna using microstrip patches of variable size,” Electr. Lett. Vol. 29, No. 8, pp. 657-658, April 1993] are among the first printed elements originally proposed. The operating principle of the reflectarrays using variable size printed elements is based on the fact that the phase of the reflected wave varies with the resonant length of the elements. If the dimensions of the element in the array are varied around its resonant length, typically half-a-wavelength, the phase of the reflected wave changes.

As an alternative to variable size printed elements, fixed size printed patches with variable length stubs can be used in which the length of the stubs is adjusted to provide the appropriate phase of the wave reflected from each element, as proposed in [R. E. Munson, H. A. Haddad, J. W. Hanlen, “Microstrip Reflectarray for Satellite Communications and RCS Enhancement or Reduction”, U.S. Pat. No. 4,684,952, August 1987] and in [R. R. Romanofsky, “Cellular reflectarray antenna and method of making same”, patent US2010/0328174 A1, December 2010]. However, the use of elements of variable size for phase control generates lower ohmic losses and lower cross-polarization than the use of elements of printed patches with variable length stubs, even though the cross-polarization introduced by the stubs may be reduced by orienting the stubs in a random way as suggested in the patent US2010/0328174.

Another concept proposed for reflectarray antennas consist of receiving the signal in each element in one linear polarization, introducing the adequate phase-shift and re-radiate the signal in the orthogonal polarization. In particular, a polarization twist reflectarray made of printed patches or dipoles with two ports connected through a reciprocal phase shifter has been patented [D. F. Bowman, “Reflectarray antenna”, U.S. Pat. No. 4,198,640, April 1980]. The problem of this design of polarization twist reflectarray is that a phase shifter is required (and two additional baluns may be required for bandwidth enlargement) in each individual reflectarray element. A polarization twist reflectarray has been proposed in [Y. U. Kim, J. P. Lim, A. G. Laquer, “Flat reflectarray antenna”, U.S. Pat. No. 6,384,787 B1, May 2001], where the elements are pairs of rectangular patches oriented in orthogonal directions that are connected by means of variable length microstrip lines, the patches and the microstrip lines being placed on the same surface. The drawbacks of this last concept of reflectarray with polarization twist are that only linear polarization can be handled, and that increased cross-polarization is introduced by the connecting microstrip lines.

Reflectarray antennas using active phase shifters have been proposed in [C. E. Profera, Jr., “Active reflectarray antenna for communication satellite frequency re-use”, U.S. Pat. No. 5,280,297, January 1994] and [A. Georgiadis, A. Collado-Garrido, “Reflectarray antenna system”, patent US2012/0162010 A1, June 2012]. In the patent [U.S. Pat. No. 5,280,297, ‘Active Reflectarray Antenna . . . ’] an active reflectarray is described, where the elements are made up of fixed size crossed dipoles or square patches that are capable to handle two independent orthogonal polarizations. Each printed element is coupled to a module containing at least two amplifiers and two phase shifters, one for each polarization. The gain of the amplifiers and the phase of the phase shifters are selected to produce a collimated beam in the desired direction for each polarization. Solid state devices are used in the patent US2012/0162010 to provide the required phase in a range of 360 degrees, and their control makes it possible to achieve beam steering capabilities for the reflectarray antenna. In both active configurations, the inclusion of active devices allows the reflected signal to be amplified, and adds additional capabilities such as beam scanning or beam reconfiguration, but the manufacturing process, power consumption, volume, weight and cost are is significantly increased. The active reflectarrays suffer from similar constraints in terms of complexity as phased array antennas, but with the additional drawback that the volume is much higher because of the external feed. This patent is focused on passive reflectarray antennas which offer clear advantages on simplicity of manufacturing and low cost with respect to active arrays or reflectarrays.

The maximum range of phase variation achieved with single layer printed elements of variable size is usually lower than 330°, and the relation between phase variation and element size is strongly non-linear because of the narrow band behaviour of single layer printed elements, which limits the working bandwidth in reflectarray antennas. The main limitation of the first designs of single layer printed reflectarrays was the narrow bandwidth, generally lower than 5% and even less for large reflectarrays. Bandwidth limitation is an inherent characteristic of reflectarrays, although much effort has been made to improve the bandwidth in recent years.

Different types of reflectarray elements have been recently introduced to improve the element bandwidth of single layer printed reflectarrays. Ridge and dogbone shaped patches [M. Bozzi, S. Germani, L. Perregrini, “Performance comparison of different element shapes used in printed reflectarrays”, Antennas and Wireless Propagation Letters, Volume 2, Issue 1, 2003 pp. 219-222], modified Malta cross patches [P. De Vita, A. Freni, G. L. Dassano, P. Pirinoli, R. E. Zich, “Broadband element for high gain single-layer printed reflectarray antenna”, Electronics Letters, Vol. 43, No. 23, 2007], and anular rings with variable length circular arcs [Y. Li, M. E. Bialkowski, A. M. Abbosh, “Single layer reflectarray with circular rings and open-circuited stubs for wideband operation”, IEEE Trans. Antennas Propagat., vol. 60, no. 9, pp. 4183-4189, September 2012] have been proposed as a wideband alternative to the more traditional elements (rectangular patches, dipoles, and rectangular patches with tuning stubs). These new elements have proven to increase the reflectarray bandwidth, but owing to their irregular shape, they generate spurious radiation that degrades the cross-polarization level. Another alternative approach suggested for bandwidth improvement of single layer reflectarray antennas is to conform the reflectarray surface to a parabolic shape surface [M. E. Cooley, T. J. Chwalek, P. Ramanujam, “Method and apparatus for improving pattern bandwidth of shaped beam reflectarrays”, European Patent EP 0 891 003 A1, January 1999], but the resulting antenna is not flat, as a result the antenna volume is increased and the manufacturing process of the parabolic reflectarray is undoubtedly more complex and more expensive than that of planar reflectarray antennas.

The bandwidth limitation of single layer printed reflectarrays with variable size patches has been overcome by the use of multilayered substrates that host two or three metallization levels of stacked rectangular patches [J. A. Encinar, “Printed circuit technology multi-layer planar reflector and method for the design thereof”, European Patent EP 1 120 856 A1, August 2001]. For instance, a focused beam multilayered reflectarray with two levels of stacked patches can be designed with a 10% bandwidth. Further bandwidth increase has been achieved by applying optimization techniques that adjust the rectangular patch dimensions in the different layers in order to obtain the required phase distribution in a predefined frequency band [J. A. Encinar and J. A. Zornoza, “Broadband design of three-layer printed reflectarrays,” IEEE Trans. Antennas Propagat., vol. 51, no. 7, pp. 1661-1664, July 2003]. The use of multilayered reflectarrays with stacked patches provides a significant improvement in bandwidth at the cost of increasing the weight, the price and the manufacturing time of the antenna, this latter effect deriving from the bonding of different reflectarray layers. The reduction of the number of array layers is particularly important in some applications, as in the case of spacecraft antennas for satellite broadcast, and antennas in millimeter and terahertz ranges.

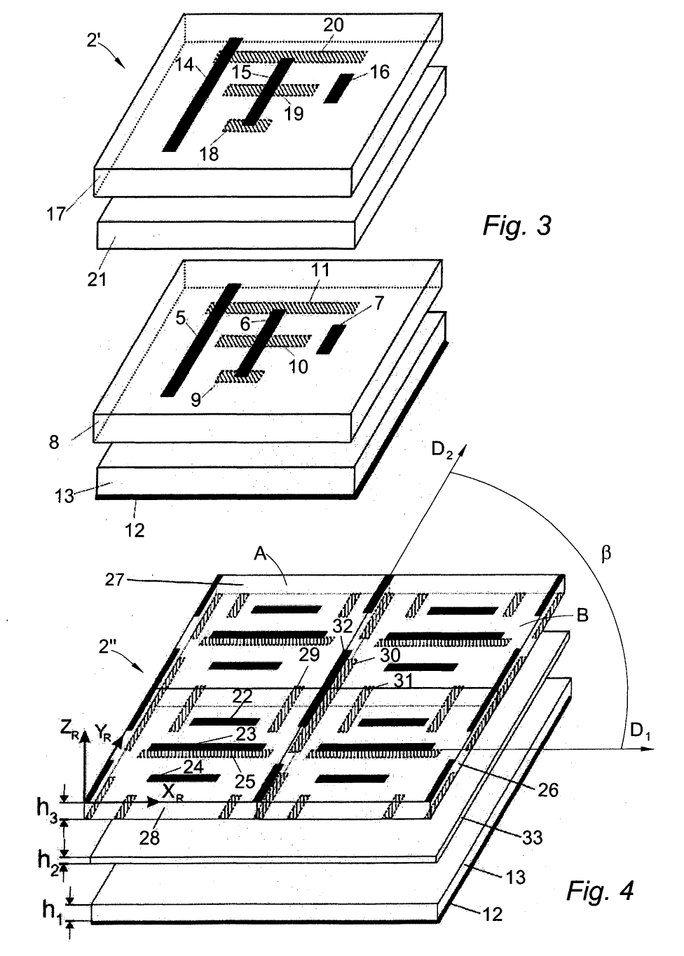

A single layer solution for bandwidth improvement that uses multi-resonant parallel edge coupled dipoles has been proposed in [J. A. Encinar and A. Pedreira, “Flat reflector antenna in printed technology with improved bandwidth and separate polarizations”, Spanish patent P200401382]. In this type of reflectarray, the lateral coupling between different dipoles provides both a phase variation range and a bandwidth similar to that of stacked rectangular patches, but owing to its single layer configuration, the parallel dipoles reflectarray is simpler to manufacture and cheaper than the stacked patches reflectarray. As shown in the patent P200401382, the parallel dipole reflectarray can also be used for dual-polarization applications if two orthogonal arrays of edge coupled parallel dipoles are printed at both sides of a dielectric layer, provided the dielectric layer is separated from the conductive ground plane by means of an additional dielectric layer. In this latter case, the phase of the elements is adjusted independently for each polarization by varying the length of the orthogonal dipoles. In fact, the dimensions of the parallel dipoles associated to each polarization can be independently optimized for bandwidth improvement as in the case of the staked patches reflectarray, and a 10% bandwidth can be easily achieved. However, in case a larger bandwidth (20%) or dual frequency operation (an antenna operating in different transmit and receive frequency bands) is required, the configuration with parallel dipoles should be combined with the configuration of stacked patches in some way. One possible solution proposed in the patent P200401382 is to use a multilayered reflectarray with four metallization levels, two levels containing two stacked arrays of edge coupled parallel dipoles that are oriented in one direction, and the other two levels containing two extra stacked arrays of edge coupled parallel dipoles in the orthogonal direction (a unit cell is shown in FIG. 3). This type of reflectarray could be designed to operate in transmit (11.45-12.75 GHz) and receive (13.5-14.5 GHz) frequencies for Ku-band space communications or broadcasting. However, the four metallization level solution duplicates the number of layers and the number of levels with metallization, and drastically increases the complexity and cost of manufacturing.

The concept of multi-resonant element is employed again in [T.-N. Chang, C.-S-. Chu, “Microstrip reflectarray antenna”, Patent US 2008/0024368 A1, January 2008], where a wideband low cross-polarization element consisting of two coupled open loops is introduced. The problem with this element is that it cannot be used for dual-polarization applications. Also, a single layer reflectarray for transmit and receive operation in Ku-band with the transmit polarization orthogonal to the receive polarization has been presented in [M. R. Chaharmir, J. Shaker, N. Gagnon, D. Lee, “Design of broadband, single layer dual-band large reflectarray using multi open loop elements”, IEEE Trans. Antennas Propagat., vol. 58, no. 9, pp. 2875-2883, September 2010]. Again, this reflectarray is based on multi-resonant elements since it uses two concentric open cross-shaped conductive rings for the receive band and two concentric open rectangular rings for the transmit band, the rings all being printed on the same surface. However, it can only handle one single polarization at each frequency band, and owing to the irregular shape of the elements, its cross-polarization levels are high.

Dual-polarization antennas for space applications require very high isolation between polarizations, which can not be always achieved with a single shaped reflector. To improve the isolation between polarizations, dual-gridded reflectors with two superimposed grid reflectors and a separate feed for each polarization are used [P. Ramanujam, P. H. Law, N. Garcia, D. A. White, “Dual gridded reflector antenna” U.S. Pat. No. 6,052,095, March 1999]. The dual-gridded antenna is a mature concept in terms of technological process and simulation tools, but suffers from high cost, large volume and mass, and large manufacturing time (15-17 months). Printed reflectarrays could overcome all these drawbacks in case the stringent space antenna requirements of coverage, cross-polarization and frequency bands were simultaneously fulfilled by a reflectarray with one or two layers of printed elements.

A dual-polarization reflectarray made up of an array of variable size crossed short-circuited dipoles has been proposed for satellite communications with frequency reuse [C. E. Profera, Jr., “Reflectarray Antenna for Communication Satellite Frequency Re-use Applications”, U.S. Pat. No. 5,543,809, August 1996]. In this antenna, the length of the orthogonal dipoles are adjusted independently to produce the required phase-shift for each polarization. The dipoles for each polarization can also be separated. This type of reflectarray exhibits severe bandwidth limitations in both embodiments because each one is based on a single layer of variable size dipoles, and therefore, it is not suitable for most commercial applications. In addition, the residual cross-polarization may not be compliant with the stringent requirements in space antennas for Telecommunications. In order to reduce the coupling between orthogonal polarizations in reflectarrays with crossed dipoles, a configuration with two stacked layers of orthogonal dipoles separated by a grid of conductive wires or strips has been proposed in [K. C. Clancy, M. E. Cooley, D. Bressler, “Apparatus and method for reducing polarization cross-coupling in cross dipole reflectarrays”, patent US2001/0050653 A1, March 2000]. This invention also includes an embodiment in which the orthogonal dipoles for the two polarizations are printed on the same side of a single layer. In this embodiment the parallel dipoles for the same polarization are gridded themselves (each dipole is divided into several close parallel narrow wires which act as a wider dipole) and arranged in rows so that the rows with orthogonal polarizations are interleaved, which reduces the coupling between orthogonal polarizations. However, the range of phase variation obtained with the reflectarray element containing gridded dipoles is similar to that obtained with a single dipole, and therefore, the bandwidth is insufficient for most commercial applications. Although the cross-polarization is drastically reduced in this invention, the technique and the embodiments are based on variable size dipoles for each polarization, which leads to severe limitations in the bandwidth of the resulting reflectarray antenna.

Reflectarray antennas have been used to generate contoured beams by using either one single layer of variable size patches [D. M. Pozar, S. D. Targonski, and R. Pokuls, “A shaped-beam microstrip patch reflectarray,” IEEE Trans. Antennas Propagat., vol. 47, no. 7, pp. 1167-1173, July 1999] or several layers of stacked patches for bandwidth improvement [J. A. Encinar and J. A. Zornoza, “Three-layer printed reflectarrays for contoured beam space applications,” IEEE Trans. Antennas Propagat., vol. 52, no. 5, pp. 1138-1148, May 2004]. Also, multilayered configurations of stacked patches have made it possible to design a dual-polarization Direct Broadcast Satellite (DBS) transmit reflectarray antenna with a different coverage in each polarization and 10% bandwidth for both coverages [J. A. Encinar et al. “Dual-Polarization Dual-Coverage Reflectarray for Space Applications”, IEEE Trans. on Antennas and Propag., Vol. 54, No. 10, pp. 2828-2837, October 2006]. Finally, a DBS reflectarray antenna made of stacked patches has been designed for dual-polarization dual frequency (transmit-receive) operation in the Ku-band [J. A. Encinar, M. Arrebola, L. De la Fuente, G. Toso, “A transmit-receive reflectarray antenna for direct broadcast satellite applications, Vol. 59, No. 9, pp. 3255-3264, September 2011]. In the previous designs, the required bandwidth for DBS applications, around a ten percent bandwidth, can be achieved by properly optimizing the patch dimensions in a three layered configuration of variable size rectangular patches. However, the required level of isolation between orthogonal polarizations in contoured beam DBS antennas (typically 30 dB) is hard to achieve with the configuration of stacked patches. It turns out that the levels of cross-polarization are low enough when the stacked patch reflectarray antennas are designed to produce a collimated beam (in the order of 30 dB below the maximum). However, when these antennas are designed to provide a wider coverage, whereas the co-polar radiation is reduced to provide a constant coverage level in the whole prescribed geographical area, the cross-polarization produced by the stacked patches is not reduced in the same proportion. As a result, the resulting level of cross-polarization might not be acceptable for contoured-beam antennas in telecommunications satellites.

In the case of reflectarrays made of either stacked patches or stacked coupled parallel dipoles, the level of cross-polarization can be reduced for the two orthogonal linear polarizations by a an adequate rotation of each reflectarray element [J. A. Encinar, M. Arrebola, W. Menzel, G. Toso, C. Mangenot, “Dual-polarization reflectarray antenna with improved cross-polarization properties”, EP2337152 A1, December 2009]. However, the use of multilayered elements increases the manufacturing complexity and cost of reflectarray antennas, which is a drawback for telecommunications and broadcast satellite applications.

A method for cross polarization compensation in reflectarray antennas has been recently proposed in [D. Bresciani, H. Legay, G. Caille, E. Labiole, “Reflector array antenna with cross polarization compensation and method for producing such an antenna, patent US2013/0099990 A1, April 2013]. In this invention the authors propose to tune separately the cross-polarization reflection coefficients of each element in such a way that the cross-polarization radiated by the whole antenna is minimized. In particular, a cross-polarization tuning procedure is suggested for elements made of crossed dipole slots and rectangular patches. In the case of the crossed dipole slots, the cross-polarization tuning is performed by rotating the arms of the dipoles, and in the case of the rectangular patches, the tuning is performed by transforming the rectangles into either trapeziums or parallelograms. Unfortunately, the two proposed embodiments are for single layer uncoupled elements with a reduced range of phase variation, and therefore, with very limited bandwidth.

As mentioned here above, the reflector and reflectarray antennas proposed so far for telecommunications and broadcast satellites have several drawbacks and limitations. On the one hand, the shaped reflector and dual-gridded antennas suffer from high manufacturing complexity, cost and production time. On the other hand, a severe limitation of reflectarray antennas is their narrow frequency band, which has been partially alleviated by means of several techniques such as the use of stacked patches, the use of single layer multi-resonant coupled elements (basically dipoles and loops), and the use of bandwidth optimization techniques. Also, the cross-polarization in reflectarrays can be too high, especially in the case of contoured beam antennas with frequency reuse for space applications, where a high isolation between polarizations is required.

As described here above, several ideas have been proposed the last decade in order to reduce the coupling between orthogonal polarizations in reflectarray antennas such as the use of orthogonal dipoles for each polarization, the individual rotation of each reflectarray element, the use of crossed dipoles with rotated arms, and the use of patches with trapezoidal or parallelogram shape.

A first technical problem is providing reflectarray antennas that fulfill the requirements of contoured-beam and low cross-polarization simultaneously in dual-polarization, for broadband or dual-frequency operation, while significantly decreasing the weight, cost and manufacturing time of the antenna, thus avoiding multilayered configurations containing too large number of metallization levels.

A second technical problem is improving the cross-polarization properties of reflectarray antennas that have sufficiently low weight, cost and manufacturing time and that fulfill simultaneously the requirements of contoured-beam in dual-polarization.

To that end, the invention relates to a wideband reflectarray antenna for dual-polarization applications, comprising a feed that radiates two orthogonal polarized electromagnetic fields and an array of phasing cells arranged in a rectangular lattice of period pₓ×p_{y} and forming a reflectarray that reflects the electromagnetic energy received from the feed, each phasing cell comprising a conductive ground plane, at least two superimposed dielectric layers, a first set of conductive dipoles printed on a first planar surface A of a first dielectric layer among the at least two superimposed dielectric layers and a second set of conductive dipoles printed on a second planar surface B facing remotely the first planar surface A and belonging to the first dielectric layer or to a second layer of the at least two superimposed dielectric layers, characterized in that:
the first set of each phasing cell contains a third set of at least two parallel dipoles oriented according to a first direction D1 with one dipole thereof centered at the phasing cell and at least one additional dipole, oriented according to a second direction D2 forming an angle β with the first direction of 90° or close to 90°, and placed with its center shifted half a period (pₓ/2,p_{y}/2) with respect to the center of the third set of dipoles, and all the dipoles of the first set are printed on the same first surface A at a prefixed distance (h_{A}) from the ground plane;
the second set of each phasing cell contains a fourth set of at least two parallel dipoles oriented according to the second direction D2 with one dipole, placed with its center shifted half a period (pₓ/2,p_{y}/2) with respect to the center of the third set of dipoles and at least one additional dipole oriented according to the first direction D1 and placed with its center aligned with the center of the third set of dipoles, and all the dipoles of the second set are printed on the same second surface B at a prefixed distance h_{B} from the ground plane;
the center of the third set and the center of at least one additional dipole are aligned along a third direction perpendicular to the layers, as well as the center of the fourth set and the center of at least one additional dipole are aligned along the third direction;
the lengths of the parallel dipoles oriented along the first direction D1 are simultaneously adjusted to provide a predetermined phase-shift at a finite number of predetermined frequencies in order to obtain a broadband performance for a first polarization of an incident electric field having its major component in the first direction, while the lengths of the parallel dipoles oriented along the second direction D2 are simultaneously adjusted to provide the required phase-shift at a finite number predetermined frequencies in order to obtain a broadband performance for a second polarization of the incident electric field orthogonal to the first polarization, which has its major component in the second direction D2.

According to specific embodiments, the wideband reflectarray antenna for dual-polarization applications comprises one or more of the following features:
the third set of each phasing cell comprises at least three parallel dipoles oriented according to the first direction D1 with one dipole centered at the phasing cell; and the fourth set of each phasing cell comprises at least three parallel dipoles oriented according to the second direction D2 with one placed with its center shifted half a period (pₓ/2,p_{y}/2) with respect to the center of the third set of dipoles;
each dipole of each phasing cell is disposed in a previously calculated orientation with respect to the phasing cell so as to reduce the cross-polarization in both orthogonal polarizations, said orientation being dependent upon the particular phasing cell considered;
the parallel dipoles of each phasing cell are disposed in a previously same calculated orientation with respect to the phasing cell so as to reduce the cross-polarization in both orthogonal polarizations, said orientation being dependent upon the particular phasing cell considered;
the reflectarray contains the dielectric layer or dielectric layers where the dipoles are printed;
the reflectarray further contains additional dielectric layers such as bonding layers, additional separators, or one dielectric layer placed above the first surface A to protect the printed dipoles;
the reflectarray comprises a multilayered antenna substrate that contains either honeycomb separators or air separation that is fixed by means of periodically placed spacers;
a reflectarray coordinate system (X_{R},Y_{R},Z_{R}) is considered and the Z_{R} axis is chosen perpendicular to the reflectarray; the phase-center of the feed is placed on the coordinate plane (X_{R},Z_{R}); in each phasing cell, the third set of at least two parallel dipoles on the first surface A and the at least one dipole on the second surface B oriented according to the first axis are parallel to the X_{R} axis while the fourth set of at least two parallel dipoles on the second surface B and the at least one dipole on the first surface A oriented according to the second axis are parallel to the Y_{R} axis;
a reflectarray coordinate system (X_{R},Y_{R},Z_{R}) is considered and the Z_{R} axis is chosen perpendicular to the reflectarray plane; the phase-center of the feed is placed on the coordinate plane (X_{R},Z_{R}); in each phasing cell, the third set of at least two parallel dipoles on the first surface A and the at least one dipole on the second surface B oriented according to the first axis are parallel to the Y_{R} axis while the fourth set of at least two parallel dipoles on the second surface B and the at least one dipole on the second surface A oriented according to the second axis are parallel to the X_{R} axis;
a reflectarray coordinate system (X_{R},Y_{R},Z_{R}) is considered and the Z_{R} axis is chosen perpendicular to the reflectarray plane; the phase-center of the feed is placed on the coordinate plane (X_{R},Z_{R}); a first local coordinate system (X_{Ri1},Y_{Ri1},Z_{Ri1}) is considered in each phasing cell i which is centered at the cell i and is parallel to the reflectarray coordinate system (X_{R},Y_{R},Z_{R}); a second local coordinate system (X_{Ri2},Y_{Ri2},Z_{Ri2}) is considered in each phasing cell i which is centered at the corner of the phasing cell i where the at least one dipole on the first surface A oriented according to the second direction is placed and is parallel to the reflectarray coordinate system (X_{R},Y_{R},Z_{R}); in each phasing cell i, the third set of at least two parallel dipoles on the first surface A and the at least one dipole on the second surface B oriented to the first axis are rotated by a first angle αₓᵢ with respect to the axis X_{Ri1} around the axis Z_{Ri1} while the fourth set of at least two parallel dipoles on the second surface B and the at least one dipole on the first surface A oriented according to the second direction are rotated with respect to the axis Y_{Ri2} by a second angle α_{yi} around the axis Z_{Ri2}, the said angles αₓᵢ and a_{y1} being previously calculated in each cell i to minimise the cross-polarization for both orthogonal polarizations of the incident field;
a reflectarray coordinate system (X_{R},Y_{R},Z_{R}) is considered and the Z_{R} axis is chosen perpendicular to the reflectarray plane; the phase-center of the feed is placed on the coordinate plane (X_{R},Z_{R}); a first local coordinate system (X_{Ri1},Y_{Ri1},Z_{Ri1}) is considered in each phasing cell i which is centered at the cell and is parallel to the reflectarray coordinate system (X_{R},Y_{R},Z_{R}); a second local coordinate system (X_{Ri2},Y_{Ri2},Z_{Ri2}) is considered in each phasing cell i which is centered at the corner of the cell where the at least one dipole on the first surface A oriented according to the second direction D2 is placed and is parallel to the reflectarray coordinate system (X_{R},Y_{R},Z_{R}); in each phasing cell i, the third set of at least two parallel dipoles on the first surface A and the at least one dipole on the second surface B are rotated by a first angle α_{yi} with respect to the axis Y_{Ri1} around the axis Z_{Ri1} while the fourth set of at least two parallel dipoles on the second surface B and the at least one dipole on the first surface A oriented according to the second direction D2 are rotated by a second angle αₓᵢ with respect to the axis X_{Ri2} around the axis Z_{Ri2}, the said angles α_{yi} and αₓᵢ being previously calculated in each cell i to minimise the cross-polarization for both orthogonal polarizations of the incident field;
a reflectarray coordinate system (X_{R},Y_{R},Z_{R}) is considered and the Z_{R} axis is chosen perpendicular to the reflectarray plane; the feed placed at the coordinate plane (X_{R},Z_{R}) radiates two orthogonal linear polarized fields, one with the main component of the electric field in the direction of the Y_{R} axis, and the other with the main component of electric field orthogonal to the Y_{R} axis and contained in the coordinate plane (X_{R},Z_{R}), the lengths of the dipoles in each phasing cell are simultaneously adjusted to produce a reflected electric field polarized in the Y_{R} direction with a constant phase shift with respect to the phase of the reflected electric field contained in the coordinated plane (X_{R},Z_{R}) at the prescribed design frequencies, so that the same radiation patterns are generated for the two orthogonal linear polarizations;
a reflectarray coordinate system (X_{R},Y_{R},Z_{R}) is considered and the Z_{R} axis is chosen perpendicular to the reflectarray plane; the feed placed at the coordinate plane (X_{R},Z_{R}) radiates two orthogonal linear polarized fields, one with the main component of the electric field in the direction of the Y_{R} axis, and the other with the main component of the electric field orthogonal to the Y_{R} axis and contained in the coordinate plane (X_{R},Z_{R}); the lengths of the dipoles in each phasing cell are simultaneously adjusted to produce a prefixed radiation pattern for the electric field polarized in the direction of Y_{R} and a different radiation pattern for the orthogonal electric field contained in the coordinate plane (X_{R},Z_{R});
a reflectarray coordinate system (X_{R},Y_{R},Z_{R}) is considered and the Z_{R} axis is chosen perpendicular to the reflectarray plane; the feed radiates two orthogonal circular polarized fields, one with Right Hand Circular Polarization (RHCP), and the other with Left Hand Circular Polarization (LHCP), and wherein the lengths of the dipoles in each phasing cell are simultaneously adjusted to produce the same phase distribution for the reflected electric field polarized in the direction of Y_{R} axis and for the reflected electric field contained in the coordinated plane of (X_{R},Z_{R}) at the prescribed design frequencies;
a reflectarray coordinate system (X_{R},Y_{R},Z_{R}) is considered and the Z_{R} axis is chosen perpendicular to the reflectarray plane; the feed placed in the coordinate plane (X_{R},Z_{R}) radiates two orthogonal linear polarized electromagnetic fields, with the electromagnetic fields slanted +45 degrees and −45 degrees with respect to the coordinate plane (X_{R},Z_{R}), respectively; and the lengths of the dipoles in each phasing cell are simultaneously adjusted to produce a reflected electric field polarized in the direction of Y_{R} with a phase shifted +90 degrees or −90 degrees with respect to the phase of the reflected electric field contained in the coordinate plane of (X_{R},Z_{R}) at the prescribed design frequencies, so that the dual linear polarization radiated by the feed is converted into dual circular polarization radiated by the reflectarray antenna;
a focused beam or contoured beam is radiated to be used in satellite broadcast or telecommunication space missions in transmit and receive frequency bands which are separated more than 20%, in particular transmit and receive Ku frequency bands which are separated more than 20%.

The invention also relates to a method for providing a wideband reflectarray antenna for dual-polarization applications as defined here above, the method comprising:
providing a reflectarray with a reflectarray coordinate system (X_{R},Y_{R},Z_{R}), and a feed configured to radiate two orthogonal polarized fields that illuminate the phasing cells of the reflectarray, each phasing cell comprising: a conductive ground plane; at least two dielectric layers; a third set of parallel dipoles oriented along a first direction aligned with one of the coordinate axis on the surface of the reflectarray (X_{R} or Y_{R}), comprising at least two dipoles printed on a first surface A of one of the dielectric layers at a prefixed distance from the ground plane h_{A}, and at least one additional parallel dipole oriented along a first direction and printed on a second surface B of one of the dielectric layers at a prefixed distance from the ground plane h_{B}, so that the center of the third set of dipoles on the first surface A and the center of the dipole or dipoles on the surface B are aligned in a direction perpendicular to the layers; a fourth set of parallel dipoles oriented at an angle of 90° with respect to the third set of dipoles, and placed with its center shifted half a period (Px/2, Py/2) with respect to the center of the third set of dipoles, the fourth set of dipoles consisting of at least two parallel dipoles printed on the second surface B and at least one additional parallel dipole printed on the first surface A, so that the center of the dipole or dipoles on the first surface A and the center of the fourth set of dipoles on the second surface B are aligned in the direction perpendicular to the layers;
decomposing the electric field radiated by the feed in each polarization that impinges on each phasing cell of the reflectarray in two components, one called X-polarization with the main component on the coordinate plane (X_{R},Z_{R}) and the other called Y-polarization with the electric filed directed along the direction of the Y_{R} axis, and defining the phase-shift that should be introduced by each phasing cell for the two polarizations of the electric field incident on the phasing cells (X-pol and Y-pol) at several frequencies, so that the electromagnetic field coming from the feed is reflected forming a prescribed collimated or shaped beam in both orthogonal polarizations at the prescribed design frequencies; characterized in that the method further comprises steps:
determining for each phasing cell the lengths of all the parallel dipoles printed on the first surface A and second surface B which are parallel to the coordinate axis X_{R}, by using a first optimization routine that iteratively calls a second analysis routine to adjust the lengths of the at least three parallel dipoles that provides the required phase-shift obtained in the step of decomposing at different frequencies, in order to obtain a broadband performance for the polarization of the reflected electric field with the major component in the coordinate plane (X_{R}, Z_{R});
determining for each phasing cell the lengths of all the parallel dipoles printed on the surfaces A and B which are parallel to the coordinate axis Y_{R}, by using an optimization routine that iteratively calls an analysis routine to adjust the lengths of the at least four parallel dipoles that provides the required phase-shift obtained in the step of decomposing at different frequencies, in order to obtain a broadband performance for the polarization of the reflected electric field with the major component in the direction of the coordinate axis Y_{R};
obtaining the photo-etching masks from the dimensions and positions of all the dipoles in each phasing cell i, manufacturing the dielectric layer (or dielectric layers) with printed dipoles, bonding the different layers to form the reflectarray panel and assembling the reflectarray and the feed by means of a supporting structure.

According to specific embodiments, the method for providing a wideband reflectarray antenna for dual-polarization applications comprises one or more of the following features:
after calculating the lengths of the printed dipoles in each phasing cell i for both polarizations in steps (608) and (610)) with the two sets of parallel dipoles oriented along the coordinate axes X_{R} and Y_{R}, a small adjustment of the rotation angles αₓᵢ and α_{yi} of the dipoles around the axes Z_{Ri1} and Z_{Ri2} is carried out by using an optimization routine that calls iteratively an analysis routine to adjust the angles (α_{Xi}, α_{Yi}) for the parallel dipoles associated to each polarization (X-pol and Y-pol) in order to simultaneously minimize the cross-polar components of the two polarizations at the prescribed design frequencies, the values of the rotation angles αₓᵢ and α_{yi} being comprised between −10 degrees and +10 degrees.

The invention will be better understood from a reading of the description of several embodiments below, given purely by way of example and with reference to the drawings, in which:

FIG. 1 is a diagrammatic view of a reflectarray antenna, according to the prior art;

FIG. 2 is an exploded view of a reflectarray phasing cell made of two orthogonal sets of three edge coupled parallel dipoles for two orthogonal linear polarizations, according to the prior art;

FIG. 3 is an exploded view of a wideband multilayered reflectarray phasing cell containing two levels of parallel dipoles for one polarization and two levels of parallel dipoles for the orthogonal polarization, according to the prior art;

FIG. 4 is an exploded view of 2x2 dual-polarization phasing cells according to a first embodiment wherein each phasing cell contains three parallel dipoles on the top surface of a dielectric layer and one dipole on the bottom surface of the same dielectric layer which are parallel to the X_{R} axis, and also contains three parallel dipoles on the bottom surface and one dipole on the top surface which are parallel to the Y_{R} axis, according to a first embodiment of the present invention;

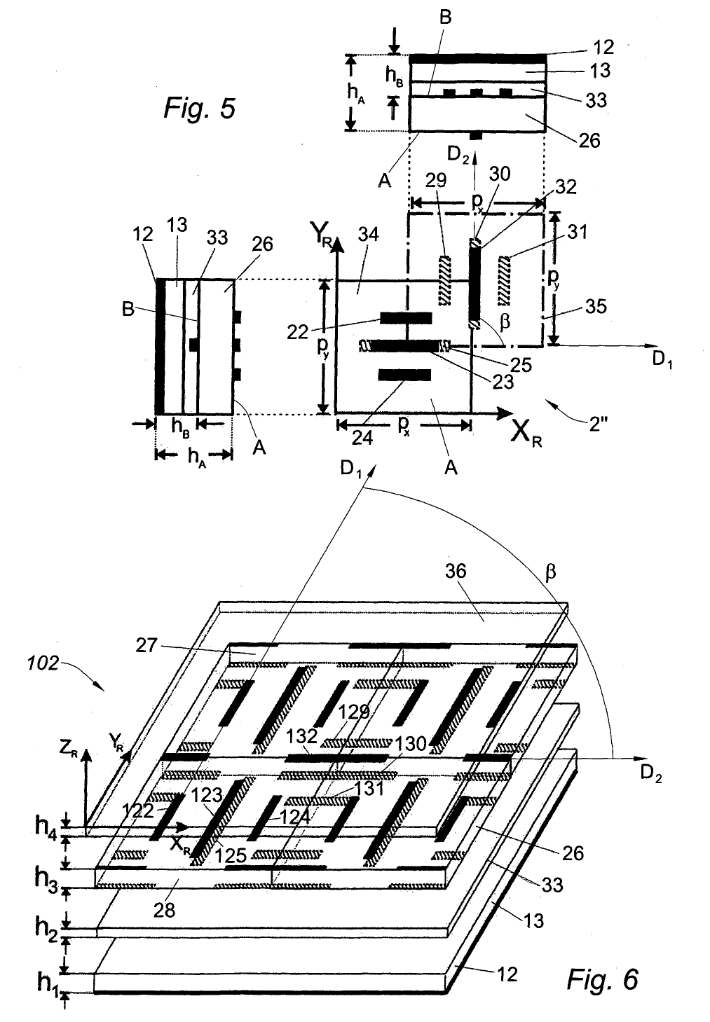

FIG. 5 are side and top views of one of the reflectarray phasing cells shown in FIG. 4, including two sets of parallel dipoles to adjust the phase in each polarization;

FIG. 6 is an exploded view of 2×2 reflectarray phasing cells according to a second embodiment wherein each phasing cell contains three dipoles on the top surface of a dielectric layer and one dipole on the bottom surface of the same dielectric layer which are parallel to the Y_{R} axis, and also contains three dipoles on the bottom surface and one dipole on the top surface which are parallel to the X_{R} axis, according to a second embodiment of the present invention;

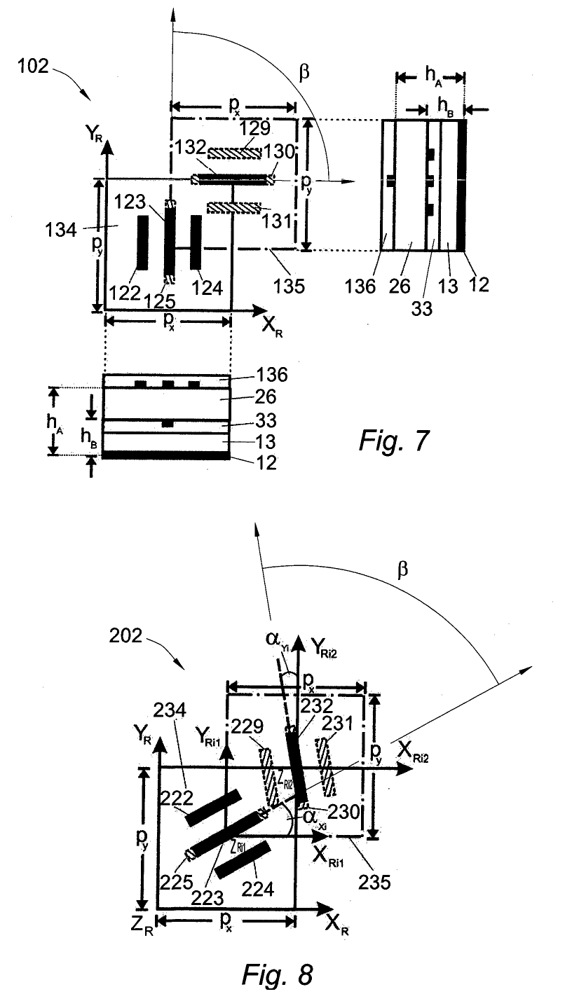

FIG. 7 are side and top views of one of the reflectarray phasing cells shown in FIG. 6, including two sets of parallel dipoles to adjust the phase in each polarization;

FIG. 8 is a top view of a reflectarray phasing cell according to a third embodiment of the invention, wherein the set of dipoles of FIG. 4 originally oriented along the X_{R} axis have been rotated by an angle αₓᵢ, and the dipoles originally oriented along the Y_{R} axis have been rotated by an angle α_{yi}, according to a third embodiment of the present invention;

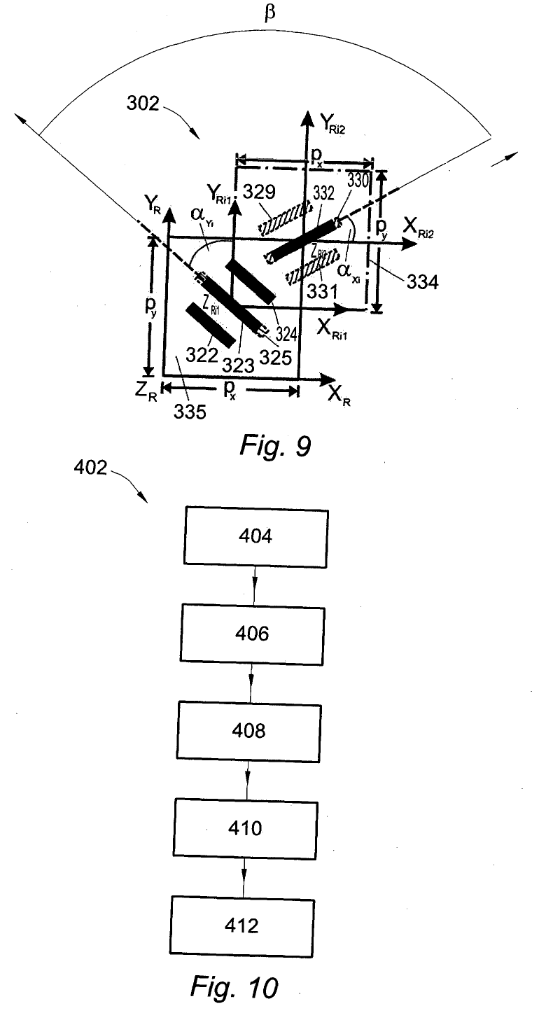

FIG. 9 is a top view of a reflectarray phasing cell, wherein the set of dipoles of FIG. 6 originally oriented along the Y_{R} axis have been rotated by an angle α_{yi}, and the dipoles originally oriented along the X_{R} axis have been rotated by an angle αₓᵢ, according to a fourth embodiment of the present invention;

FIG. 10 is a flow chart of a method according the invention for designing and manufacturing a wideband reflectarray antenna operating in Ku band and having phasing cells as shown in FIGS. 4-7;

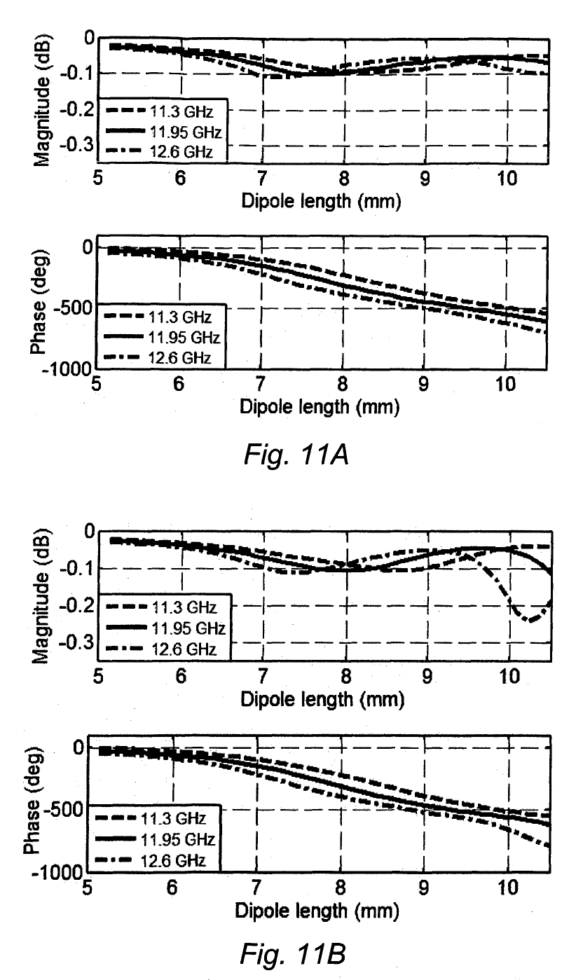

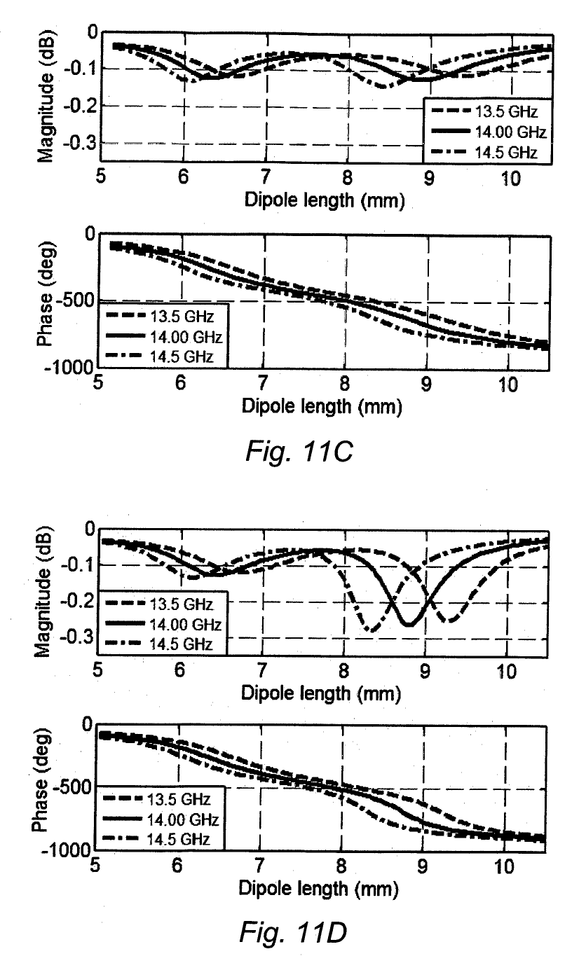

FIG. 11A shows the magnitude and phase of the reflection coefficient for an X-polarized wave normally incident on a periodic multilayered structure wherein the unit cell is the reflectarray unit cell of FIG. 4, at the transmit frequencies in Ku-band;

FIG. 11B shows the magnitude and phase of the reflection coefficient for an Y-polarized wave normally incident on a periodic multilayered structure wherein the unit cell is the reflectarray unit cell of FIG. 4, at the transmit frequencies in Ku-band;

FIG. 11C shows the magnitude and phase of the reflection coefficient for an X-polarized wave normally incident on a periodic multilayered structure wherein the unit cell is the reflectarray unit cell of FIG. 4, at the receive frequencies in Ku-band;

FIG. 11D shows the magnitude and phase of the reflection coefficient for an Y-polarized wave normally incident on a periodic multilayered structure wherein the unit cell is the reflectarray unit cell of FIG. 4, at the receive frequencies in Ku-band;

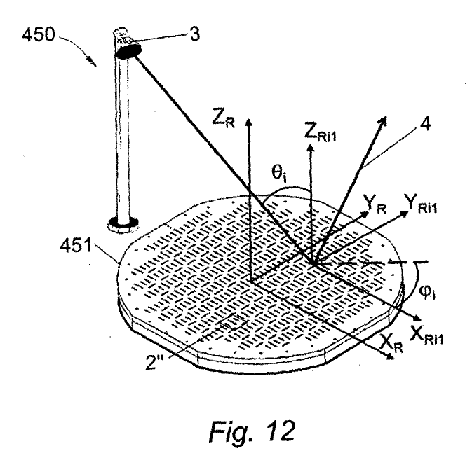

FIG. 12 is a diagrammatic view of a proposed reflectarray composed of a plurality of the new reflective unit cells illuminated by a feed-horn;

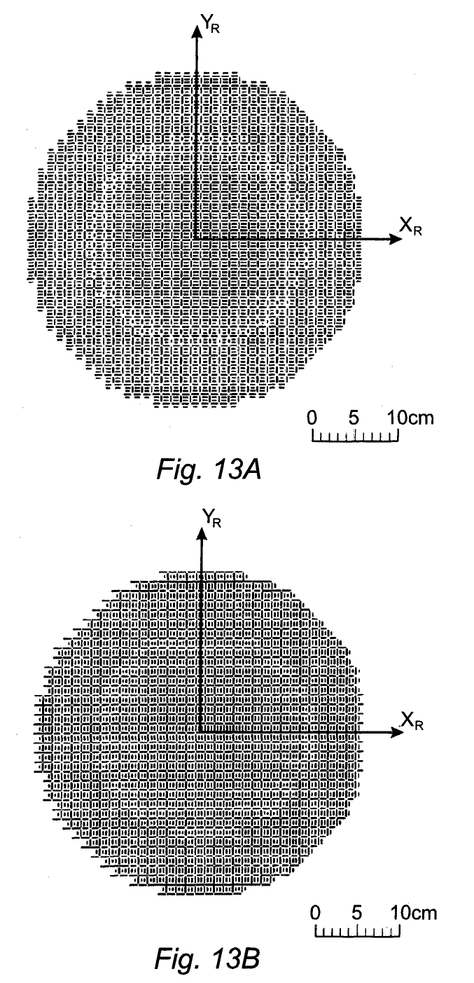

FIG. 13A shows an example of a mask of the top surface A of the reflectarray antenna, according to the first embodiment of the present invention;

FIG. 13B shows an example of a mask of bottom surface B of the reflectarray antenna, according to the first embodiment of the present invention;

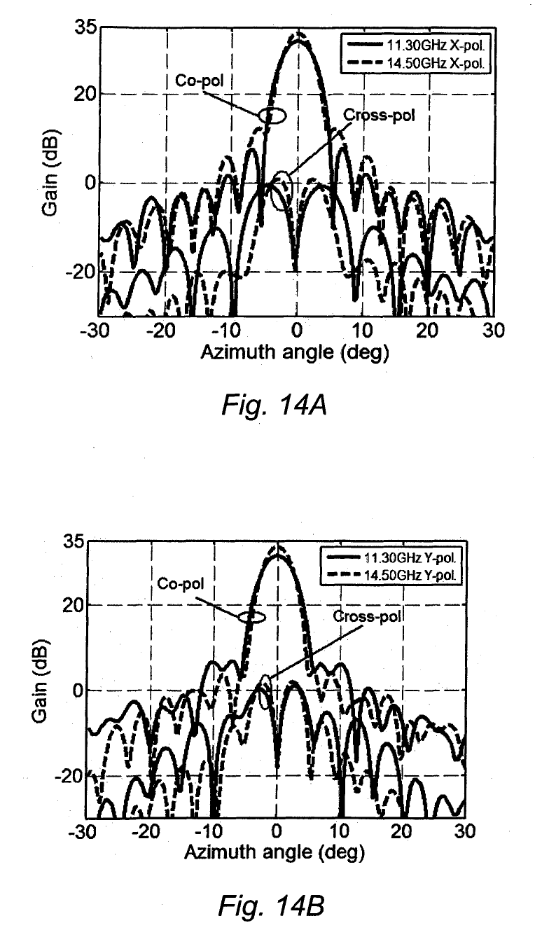

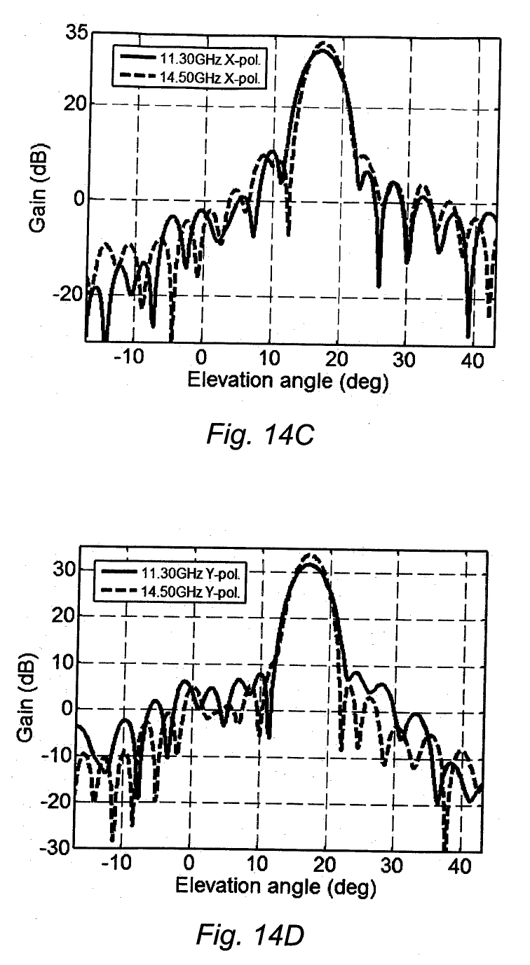

FIG. 14A shows the X-polarization co-polar and cross-polar radiation patterns in the plane tilted by 16.9 degrees with respect to the coordinate plane Y_{R}-Z_{R} (azimuth plane) for the reflectarray antenna with surface A as in FIG. 13A and surface B as in FIG. 13B. Results are presented for both the lower frequency of the transmit operation band f=11.3 GHz and the upper frequency of the receive operation band f=14.5 GHz;

FIG. 14B shows the Y-polarization co-polar and cross-polar radiation patterns in the plane tilted by 16.9 degrees with respect to the coordinate plane Y_{R}-Z_{R} (azimuth plane) for the reflectarray antenna with surface A as in FIG. 13A and surface B as in FIG. 13B. Results are presented for both the lower frequency of the transmit operation band f=11.3 GHz and the upper frequency of the receive operation band f=14.5 GHz;

FIG. 14C shows the X-polarization co-polar and cross-polar radiation patterns in the plane X_{R}-Z_{R} (elevation plane) for the reflectarray antenna with surface A as in FIG. 13A and surface B as in FIG. 13B. Results are presented for both the lower frequency of the transmit operation band f=11.3 GHz and the upper frequency of the receive operation band f=14.5 GHz;

FIG. 14D shows the Y-polarization co-polar and cross-polar radiation patterns in the plane X_{R}-Z_{R} (elevation plane) for the reflectarray antenna with surface A as in FIG. 13A and surface B as in FIG. 13B. Results are presented for both the lower frequency of the transmit operation band f=11.3 GHz and the upper frequency of the receive operation band f=14.5 GHz;

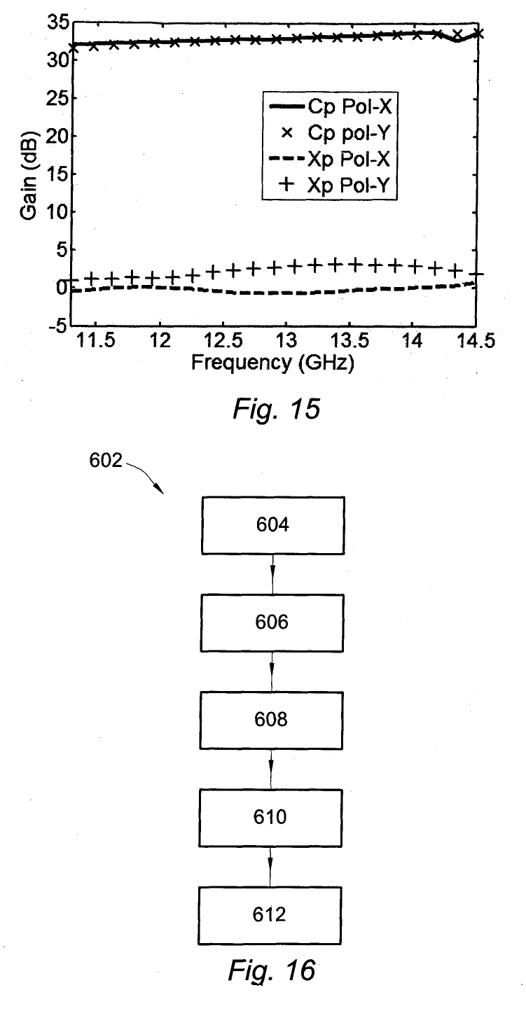

FIG. 15 shows the maximum co-polar radiation gain and the maximum cross-polar radiation level for the reflectarray with surface A as in FIG. 13A and surface B as in FIG. 13B. Results are presented for the X-polarization and the Y-polarization in the frequency interval going from the lower frequency of the transmit operation band to the upper frequency of the receive operation band (11.3<f<14.5 GHz);

FIG. 16 is a flow chart of a general method according the invention for designing and manufacturing a wideband reflectarray antenna for dual-polarization applications and having the phasing cells of the invention.

According to the prior art and the FIG. 1 a reflectarray 1 comprises a plurality of reflective unit cells 2 illuminated by a feed 3. In each reflective unit cell 2, also called reflectarray element, an adjustment is introduced in the phase of the reflected field so that the divergent field coming from the feed 3 is reflected as a collimated or a shaped beam in a given direction 4.

In the prior state of the art, it has been demonstrated that reflectarray antennas can be designed to be compliant with most of the stringent requirements for communications satellites. Two critical issues in the design of reflectarray antennas for spacecraft applications are the large bandwidth, especially in transmit-receive operation, and the low cross-polarization levels required for dual-polarization antennas. So far, these two problems have been overcome to a large extent by the use of reflectarray elements made of either stacked rectangular patches or two orthogonal sets of parallel dipoles in a multilayered substrate, involving at least three levels of metallizations in the cases of rectangular patches, and at least four levels in the case of parallel dipoles.

As a first example of prior art, the FIG. 2 depicts a perspective view of an exemplary reflectarray cell 2 comprising a first set of three parallel conductive dipoles 5, 6 and 7, printed on the top side of a dielectric layer 8, and a second set of three parallel conductive dipoles 9, 10 and 11, printed on the bottom side of the same dielectric layer 8, and oriented in a direction orthogonal to the direction of the top dipoles 5, 6 and 7. The bottom dipoles 9, 10 and 11 of the second set are separated from a conductive plane 12 by means of an additional dielectric layer 13. The phase of the reflected field for each linear polarization is controlled independently by varying the lengths of the dipoles printed on each side of the dielectric layer 8 located on the top of the unit cell 2. The phase of the reflected field is adjusted independently for each polarization by varying the length of each set of parallel dipoles 5, 6, 7 and 9, 10, 11. Such a reflectarray element 2 can be used to provide a 10% bandwidth; however, to achieve a larger bandwidth, namely 20%, or dual frequency operation, namely an antenna operating in transmit and receive frequency bands, additional stacked layers with parallel dipoles should be added for each polarization.

As a second of prior art, the FIG. 3 depicts a perspective view of a reflectarray cell 2′, derived from the reflectarray cell 2 of FIG. 1, and comprising the first set of the three parallel conductive dipoles 5, 6 and 7 printed on the top side of the dielectric layer 8, and the second set of the three parallel orthogonal dipoles 9, 10 and 11 printed on the bottom side of the dielectric layer 8. The bottom dipoles 9, 10 and 11 of the second set are separated from the conductive plane 12 by means of the additional dielectric layer 13. The reflectarray cell 2′ also comprises a third set of three parallel conductive dipoles 14, 15 and 16, printed on the top side of a second additional dielectric layer 17 and a fourth set of three parallel orthogonal dipoles 18, 19 and 20, printed on the bottom side of the second additional dielectric layer 17. The fourth set of parallel dipoles 18, 19 and 20 is separated from the first set of parallel dipoles 5, 6 and 7 by a third additional dielectric layer 21. The dipoles of the first and third sets 5, 6, 7, 14, 15 and 16 are all mutually parallel, and the dipoles of the second and fourth sets 9, 10, 11, 18, 19 and 20 are mutually parallel and orthogonal to the dipoles of the first and third sets. The phase of the reflected field for each linear polarization is controlled at several frequencies by varying the lengths of the six printed dipoles, located in two different levels of metallizations and oriented in the direction of the incident electric field. Since the reflectarray element shown in FIG. 3 contains stacked dipoles for each polarization, its bandwidth will be larger than that provided by the reflectarray element shown in FIG. 2. However, this bandwidth improvement is achieved at the expense of doubling the number of metallization levels, which considerably increases the complexity and cost of the manufacturing process.

According to a first embodiment of the invention, a wideband reflectarray antenna for dual-polarization applications comprises a feed 3 as described in the FIG. 1 that radiates two orthogonal polarized fields and an array of phasing cells, also called reflectarray, arranged in a rectangular lattice of period pₓ×p_{y}, that reflects the electromagnetic energy received from the feed 3.

As described in the FIGS. 4 and 5, each phasing cell 2″ used in the first embodiment of the invention comprises the conductive ground plane 12, a first set of conductive dipoles 22, 23, 24, 32, printed on a first planar surface A, designated also by the numeral reference 27, of a first dielectric layer 26 at a prefixed distance h_{A} from the ground plane 12, and a second set of conductive dipoles 25, 29, 30, 31 printed on a second different planar surface B, designated also by the numeral reference 28, of the first dielectric layer at a prefixed distance h_{B} from the ground plane 12. The first set of conductive dipoles, printed on the first surface A, of each phasing cell 2″ contains a third set of at least two parallel dipoles, here the three dipoles 22, 23, 24, oriented according to a first direction D1 and centered at the periodic cell, here through the dipole 23, and at least one additional dipole, here the single conductive dipole 32, oriented according to a second direction D2 forming an angle β with the first direction of 90° or close to 90°, and placed with its center shifted half a period (pₓ/2,p_{y}/2) with respect to the center of the third set of dipoles 22, 23, 24.

The second set of conductive dipoles, printed on the second surface B, of each phasing cell 2″ contains a fourth set of at least two parallel dipoles, here the three dipoles 29, 30, 31, oriented according to the second direction D2 and placed with its center, here through the dipole 30, shifted half a period (pₓ/2,p_{y}/2) with respect to the center of the third set of dipoles 22, 23, 24, and at least one additional dipole, here the single conductive dipole 25, oriented according to the first direction and placed with its center aligned with the center of the third set of dipoles 22, 23, 24.

The dipoles 22, 23, 24 of the third set on the first surface A and the additional dipole 25 on the second surface B must be parallel and the centers of the third set and the additional dipole must be aligned according to a third direction that is the direction of thickness of the layers.

The dipoles 29, 30, 31 of the fourth set on the second surface B and the additional dipole 32 on the first surface A must be parallel and the centers of the fourth set and the additional dipole must be aligned according to the third direction.

In the FIG. 4, a reflectarray coordinate system (X_{R},Y_{R},Z_{R}) is considered and the Z_{R} axis is chosen perpendicular to the reflectarray surface. The part of the phasing cell 2″ associated to the incident electric field with the component tangential to the reflectarray surface in the X_{R} direction contains the four parallel dipoles 22, 23, 24, 25 oriented along the X_{R} axis, three of these dipoles 22, 23, 24 forming the third set. The part of the phasing cell 2″ associated to the incident electric field with the component tangential to the reflectarray surface in the Y_{R} direction is shifted by half a period in both X_{R} and Y_{R} directions and contains the four parallel dipoles 29, 30, 31,32 oriented along the Y_{R} axis, three of these latter dipoles 29, 30, 31 forming the fourth set. The dipoles are printed on the two sides A (27) and B (28) of the dielectric layer 26.

As shown in FIG. 5, the top first surface A 27 is placed at a distance h_{A}=h₁+h₂+h₃ from the ground plane 12, wherein h1, h2, h3 denote respectively the thicknesses of the dielectric layers 13, 33 and 26. The bottom second surface B 28 is placed at a distance h_{B}=h₁+h₂ from the ground plane 12.

The three dipoles 22, 23, 25 along the X_{R} axis forming the third set and the dipole 32 oriented along the Y_{R} axis 32 are printed on the same first surface A, while the dipole 25 oriented along the X_{R} axis and the three dipoles 29, 30, 31 forming the fourth set and placed along the Y_{R} axis are printed on the same second surface B. The center of the third set of the three dipoles 22, 23, 25, printed on the first surface A and oriented in the X_{R} direction, and the center of the parallel dipole 32 on the second surface B also oriented in the X_{R} direction are aligned in the third direction perpendicular to the layers 13, 33, 26, namely the direction along the thickness of the dielectric layer 26. Also, the center of the fourth set of the three dipoles 29, 30, 31, printed on the second surface B oriented in the Y_{R} direction, and the center of the parallel dipole 32, printed on the first surface A also oriented in the Y_{R} direction, are aligned in the third direction perpendicular to the layers.

As shown in FIG. 4, the conductive dipoles 22, 23, 24, 25, 29, 30, 31, 32 are printed on both sides of the same dielectric layer 26. An additional dielectric layer is needed as a separator 13 between the layer containing the dipoles and the ground plane 12, and the two layers can be bonded by means of a thin bonding film 33.

In a variant, the dipoles could have also be printed on the sides of two different dielectric layers, e.g., on the first surface 27 A on the top of the dielectric layer 26 and on a second surface being both a top surface of the separator layer 13 and a bottom surface relative to the first surface A.

As shown in the top view of the FIG. 5, one dual-polarization phasing cell of the wideband reflectarray, here the phasing cell 2″ comprises two phasing units 34, 35, the first unit 34 for the polarization with the tangential incident electric field in X_{R} direction including the third set of dipoles 22, 23, 24 and the additional dipole 25, and the second unit 35 for the polarization with the tangential incident electric field in the Y_{R} direction, which is shifted by half a period in both X_{R} and Y_{R} directions and that includes the fourth set of dipoles 29, 30, 31 and the additional dipole 32. The FIG. 5 also shows the respective lateral views of the first phasing unit 34 associated to X_{R} polarization and of the second phasing unit 35 associated to Y_{R} polarization.

The number of dielectric layers present in the reflectarray may increase if a radome is required for structural or environmental concerns or for technological reasons in the manufacturing process. Whereas the lengths of the dipoles 29, 30, 31, 32 oriented along the Y_{R} axis can be adjusted to generate the adequate phase-shift in the component of the reflected electric field along the Y_{R} direction, the lengths of the dipoles 22 23, 24, 25 oriented along the X_{R} axis can be independently adjusted to generate the adequate phase-shift in the component of the reflected electric field contained in the coordinate plane (X_{R},Z_{R}) at the prescribed design frequencies, which shows the dual-polarization capabilities of this reflectarray element or phasing cell. Also, since the broadside coupling between stacked dipoles is stronger than the lateral coupling between coplanar dipoles, the bandwidth of the element 2″ will be clearly higher than the bandwidth of a phasing the element based on edge coupled dipoles as described in the FIG. 2, and will be comparable to the bandwidth performance of a phasing element based on stacked rectangular patches.

With the structure of the phasing cell 2″, the bandwidth and cross-polarization performance are similar to those of the phasing element made of stacked sets of parallel dipoles as described in FIG. 3, while requiring only two levels of metallizations and a smaller number of layers with the consequent reduction of cost and manufacturing time.

Since the dipoles of each phasing cell are oriented in two different directions, the lengths of the parallel dipoles oriented in the first direction D1 on the surfaces A and B, are firstly and simultaneously adjusted to provide the required phase-shift at different frequencies in order to obtain a broadband performance for the polarization of the incident electric field with the major component in the first direction D1 of the said dipoles. Also, the lengths of the parallel dipoles, oriented in the second direction D2 that is orthogonal or quasi-orthogonal with the first direction, and printed on the surfaces A and B, are secondly and simultaneously adjusted to provide the required phase-shift at different frequencies in order to obtain a broadband performance for the polarization of the incident electric field orthogonal to the previous one, which has the major component in the second direction D2 of the secondly adjusted set of dipoles.

In a variant, the orientation angles of the parallel dipoles associated to each orthogonal polarization will be conveniently adjusted to reduce the cross-polarization in both orthogonal polarizations as it will be described later for the third and fourth embodiments of the invention.

Apart from the dielectric layer or dielectric layers where the dipoles are printed, the reflectarray antenna may contain some additional dielectric layers such as bonding layers, additional separator layers, or one dielectric layer above the surface A—called radome—aimed at protecting the printed dipoles. The separator layers may be made of either a solid dielectric, a low density material as foam or honeycomb, or directly air by using periodically placed spacers to maintain a uniform separation between layers.

According to a second embodiment of the invention, a wideband reflectarray antenna for dual-polarization applications comprises the same configuration of the top level defined components used for the first embodiment of the wideband reflectarray antenna, such as the feed 3 described in the FIG. 1 that radiates two orthogonal polarized fields, and an array of phasing cells, arranged in a rectangular lattice of period pₓ×p_{y}, that reflects the electromagnetic energy received from the primary feed 3.

According to the FIGS. 6 and 7 and the second embodiment, the roles of the conductive dipoles as described in the first embodiment of FIGS. 4 and 5 are exchanged, the other elements of the phasing cell 102 of the second embodiment remaining the same as ones of the first embodiment and being designated by the same numeral references, namely 12, 13, 26, 27, 28, 33.

In the second embodiment, the first phasing unit 34 of the first embodiment that includes the conductive dipoles 22, 23, 24, 25 has been replaced respectively by a first phasing unit 134 including conductive dipoles 122, 123, 124, 125, the orientation thereof is along the Y_{R} axis instead of X_{R} axis. Similarly, the second phasing unit 35 and the conductive dipoles 29, 30, 31, 32 of the first embodiment have been replaced respectively by a first phasing unit 135 and conductive dipoles 129, 130, 131, 132, the orientation thereof is now along the X_{R} axis instead of Y_{R} axis.

Thus, in the second embodiment the dipoles adjusted to generate the adequate phase shift in each of the components of the reflected electric field, are now the opposite to those adjusted in the first embodiment of FIGS. 4 and 5.

In the FIGS. 6 and 7, an additional layer 136 forming a so-called radome is included above the first surface A 27 to protect the conductive dipoles printed on the first surface A.

When working with orthogonal dipoles oriented along the reflectarray axes, the optimization of the dipole lengths to fulfil the phase requirements at different frequencies will make it possible to achieve a large bandwidth. However, one of the goals of the present invention is its application for satellite dual-polarization telecommunication antennas, which not only require a large bandwidth but also have to respect stringent requirements in cross-polarization discrimination. Since the first and second embodiments as described in FIGS. 4 to 7 may not fulfill the low cross-polarization levels required for spacecraft antennas, once the length of the dipoles have been optimized for each polarization, the sets of parallel dipoles can be independently rotated at each cell in order to minimize the cross-polarization introduced by each reflectarray cell.

According to a third embodiment of the invention, a wideband reflectarray antenna for dual-polarization applications comprises the same configuration of the top level defined components as used for the first embodiment of the wideband reflectarray antenna.

As shown in FIG. 8, an exemplary phasing cell 202 is illustrated that can be considered as a generic phasing cell i, the index i identifying individually each cell and ranging from 1 to an integer number N as the total number of the phasing cells forming the wideband reflectarray.

Four dipoles 222, 223, 224 and 225 of the phasing cell 202 are respectively the four dipoles 22, 23, 24 and 25 of the phasing cell 2″ originally oriented along the X_{R} axis in the first embodiment, three of them 22, 23, 24 on the first surface A 27 and the remaining one 25 on the second surface B 28 , that are rotated by a first angle αₓᵢ around an axis Z_{Ri1}, while four dipoles 229, 230, 23, 232 of the phasing cell 202 are respectively the four dipoles 29, 30, 31, 32 of the phasing cell 2″ originally oriented along the Y_{R} axis in the first embodiment, that are rotated by a second angle α_{yi} around an axis Z_{Ri2}. The axes Z_{Ri1} and Z_{Ri2} belong to two local coordinate systems (X_{Ri1},Y_{Ri1},Z_{Ri1}) and (X_{Ri2},Y_{Ri2},Z_{Ri2}) defined in each dual-polarization phasing cell i, whose origins are located at the center of the phasing units 234, 235 for X_{R} and Y_{R} polarizations respectively, and whose axes are parallel to the axes of the reflectarray coordinate system (X_{R},Y_{R},Z_{R}). Whereas the lengths of the dipoles are adjusted to produce the required collimated or shaped beam for each of the two components of the reflected electric field at the prescribed frequency band, the angles of rotation αₓᵢ and α_{yi} are simultaneously adjusted in each reflectarray cell to minimize the cross-polarization of both reflected field components at the prescribed frequency band.

According to a fourth embodiment of the invention, a wideband reflectarray antenna for dual-polarization applications comprises the same configuration of the top level defined elements 3, 12, 13, 26, 33 as used for the first, second, and third embodiments of the wideband reflectarray antenna.

As shown in FIG. 9, an exemplary phasing cell 302 of the fourth embodiment is illustrated that can be considered as a generic phasing cell i, the index i identifying in individually each cell and ranging from 1 to an integer number N as the total number of the phasing cells forming the wideband reflectarray.

Four dipoles 322, 323, 324 and 325 of the phasing cell 302 are respectively the four dipoles 22, 23, 24 and 25 of the phasing cell 102 originally oriented along the Y_{R} axis in the second embodiment, three of them 22, 23, 24 on the first surface A 27 and the remaining one on the second surface B 28, that are slightly rotated by a first angle α_{yi} around the axis Z_{Ri1}, while four dipoles 329, 330, 331, 332 of the phasing cell 302 are respectively the four dipoles 29, 30, 31, 32 of the phasing cell 102 originally oriented along the X_{R} axis in the second embodiment, three of them 29, 30, 31 on the second surface B 28 and the remaining one 32 on the first surface A 27, are slightly rotated by an angle αₓᵢ around the axis Z_{Ri2}. Here, the local coordinate systems (X_{Ri1},Y_{Ri1},Z_{Ri1}) and (X_{Ri2},Y_{Ri2},Z_{Ri2}) are defined in each dual-polarization phasing cell i, whose origins are located at the center of the phasing cells units 335, 334 associated to Y_{R} and X_{R} polarizations respectively, and whose axes are parallel to the axes of the reflectarray coordinate system (X_{R},Y_{R},Z_{R}). As for the third embodiment, the first and second angles of rotation αₓᵢ and α_{yi} are simultaneously adjusted in each reflectarray cell in order to minimize the cross-polarization of the two reflected field components of the antenna at the prescribed frequency band.

The antenna is designed by adjusting the lengths of the dipoles to produce the adequate phase-shift in the two components of the reflected field that is required to collimate or to shape the beam in dual-polarization, either in a broad frequency band or in two separate bands used for transmit and receive, when illuminated by the feed located at a focal point (in transmit mode); or to receive radio-frequency signals from a given direction in dual-polarization and in the same frequency bands, by concentrating them at the focal point where the feed is located. Once the length of the dipoles have been optimized for each component of the reflected field, the two sets of dipoles can be independently rotated at each cell to minimize the cross-polarization produced at each reflectarray cell. For the analysis of the reflectarray antenna, the co-polar and cross-polar components of the reflected field at each phasing cell i are computed by using the local periodicity assumption, i.e., by assuming that the phasing cell is surrounded by an infinite periodic array of phasing cells of the same type. Once the components of the reflected field are known at each cell, the co-polar and cross-polar radiation patterns of the reflectarray antenna are computed.

One advantage of the present invention is that its improved bandwidth and cross-polarization properties make it suitable for being used in space antennas as an alternative to conventional shaped reflectors. A shaped reflector of a satellite for direct broadcast television consists of a reflector with deformities on its surface, so that the radiation pattern illuminates a certain geographical area. The design and construction of shaped reflectors are specifically carried out for each coverage. The manufacturing process requires moulds, which are very expensive and cannot be reused for other antennas. The proposed reflectarray antenna and its design process for bandwidth and cross-polarization improvement can be used to design telecommunications satellite antennas with the same electrical performances as those provided by shaped reflectors, providing a significant reduction in the production costs and time because of the elimination of the custom moulds.

As a variant, regardless the embodiment considered here above in FIGS. 4 to 7, the number of dipoles of the third set is equal to 2 and/or the number of dipoles of the fourth set is equal to 2.

As a variant, regardless the embodiment considered here above in the FIGS. 4 to 7, the number of dipoles of the third set is higher than or equal to 4 and/or the number of dipoles of the fourth set is higher than or equal to 4. As a variant, regardless the embodiment considered here above in the FIGS. 4 to 7, the number of dipoles of the third set is different from the number of dipoles of the fourth set.

It should be noted that in all the embodiments considered here above in the FIGS. 4 to 7, two levels of metallization are preferred for printing the conductive dipoles of the phasing cells. More generally, the reflectarray antenna is formed by a planar array of phasing cells arranged in a rectangular lattice, where each phasing cell is made of a multilayered substrate with two levels of metallizations. Each metallization level of the phasing cell contains a set of at least two parallel dipoles, and at least one additional printed dipole, oriented in orthogonal or quasi-orthogonal direction in respect of the dipoles of the set, and shifted half a period in each direction with respect to the set of parallel dipoles. In addition, the dipoles printed on one level of metallization are also shifted by half a period in each direction and rotated 90 degrees or close to 90 degrees with respect to the dipoles printed on the other level of metallization. As a result, the reflectarray cell comprises one phasing cell for one polarization made of parallel dipoles stacked in two layers, and one second phasing cell for the orthogonal polarization also made of parallel dipoles stacked in two layers, and shifted by half a period in each direction with respect the dipoles for the first polarization.

As a further embodiment of the wideband reflectarray antenna for dual-polarization applications, the antenna is wideband reflectarray antenna for dual linear polarization wherein the feed placed at the coordinate plane (X_{R},Z_{R}) radiates two orthogonal linear polarized fields, one with the main component of the electric field in the direction of the Y_{R} axis, and the other with the main component of electric field orthogonal to the Y_{R} axis and contained in the coordinate plane (X_{R},Z_{R}). The lengths of the dipoles in each phasing cell are simultaneously adjusted to produce a reflected electric field polarized in the Y_{R} direction with a constant phase shift with respect to the phase of the reflected electric field contained in the coordinate plane (X_{R},Z_{R}) at the prescribed design frequencies, so that the same radiation patterns are generated for the two orthogonal linear polarizations. Also, the lengths of the dipoles in each phasing cell can be simultaneously adjusted to produce a prefixed radiation pattern for the electric field polarized in the direction of Y_{R} and a different radiation pattern for the orthogonal electric field contained in the coordinate plane (X_{R},Z_{R}).

As a further embodiment of the wideband reflectarray antenna for dual-polarization applications, the antenna is a wideband reflectarray antenna for dual circular polarization wherein the feed radiates two orthogonal circular polarized fields, one with Right Hand Circular Polarization (RHCP), and the other with Left Hand Circular Polarization (LHCP), and wherein the lengths of the dipoles in each phasing cell are simultaneously adjusted to produce the same phase distribution for the reflected electric field polarized in the direction of Y_{R} axis and for the reflected electric field contained in the coordinate plane (X_{R},Z_{R}) at the prescribed design frequencies. An alternative configuration of wideband reflectarray antenna for dual circular polarization, also considered in this invention, is obtained when the feed placed at the coordinate plane (X_{R},Z_{R}) radiates two orthogonal linear polarized fields, with the electric field slanted +45 degrees and −45 degrees with respect to the coordinate plane (X_{R},Z_{R}), respectively, and when the lengths of the dipoles in each phasing cell are simultaneously adjusted to produce a reflected electric field polarized in the direction of Y_{R} with a phase shifted +90 degrees or −90 degrees with respect to the phase of the reflected electric field contained in the coordinated plane (X_{R},Z_{R}) at the prescribed design frequencies, so that the dual linear polarization radiated by the feed is converted into dual circular polarization radiated by the reflectarray antenna.

In accordance with a further aspect of the present invention, a method is provided for designing and manufacturing a wideband dual-frequency dual-polarization reflectarray antenna as described here above for the first, second, third and fourth embodiments, and operating in Ku-band.

According to FIG. 10 and as an example, such a method comprises a set 402 of steps 404, 406, 408, 410, 412.

In a first step 404, the technology and the materials to be used in the fabrication of the reflectarray antenna are chosen, and the reflectarray phasing cell is defined to provide a linear phase response in a range larger than360 degrees in one broad band or two frequency bands with low losses and low cross-polarization. In the example that is described, 2.362 mm thick Diclad 527B0935555 has been chosen as separator layer 13, which has a relative dielectric constant of 2.55 and a loss tangent of 0.0009. The dipoles are printed at both sides of 1.524 mm thick Diclad 88060605517 dielectric layer 26, which has a relative dielectric constant of 2.17, a loss tangent of 0.0009, and a 18 micron copper cladding. A bonding layer 76 microns thick Thermoplastic Bonding Film 6250 is used as layer 33 to bond the separator layer 13 and the dielectric layer 26 where the dipoles are printed as shown in FIG. 4. The bonding layer 33 is characterized by its relative dielectric constant of 2.32 and a loss tangent of 0.0013.

The FIGS. 11A to 11D show the magnitude and phase of the reflection coefficients of a plane wave normally incident on one of the phasing cells of the reflectarray in the case where the phasing cell is assumed to be surrounded by a periodic environment and the phasing cell of FIG. 4. A cell size of 11.5 mm×11.5 mm has been assumed. The curves have been obtained by means of the routine based on the Method of Moments in the spectral domain. In the FIGS. 11A to 11D the dipoles 25 and 30 of FIG. 4 are assumed to have a length I varying from 5 mm to 10.5 mm, the dipoles 22 and 24 are assumed to have a length 0.631, the dipoles 29 and 31 are assumed to have a length 0.581, the dipole 23 is assumed to have a length 0.931, and the dipole 32 is assumed to have a length 0.951. Note that the phase ranges covered by the novel phasing cell introduced in this invention is of about 600° in the transmit band and about 800° in the receive band, which are sufficiently large for design purposes. Also, the dependence of the reflection phase on the dipole length is linear and very smooth, which is typical of wideband reflectarray elements such as the element made of rectangular stacked patches. Finally, the losses are typically below 0.15 dB for the X-polarization and below 0.25 dB for the Y-polarization, which is consequent with the low values of the loss tangent of the dielectric substrates employed.

In a second step 406, a reflectarray antenna is designed to produce or receive a collimated or a shaped beam in the two orthogonal polarizations. As shown in the perspective view of FIG. 12, a reflectarray 451 composed of a plurality of reflective phasing cells 2″ as described in FIG. 4 and illuminated by the feed-horn 3. In each reflective phasing cell 2″, also called reflectarray element, an adjustment is introduced in the phase of the reflected field for the two orthogonal polarizations so that the divergent field coming from the feed 3 is reflected as a collimated or a shaped beam in a given direction 4 at several frequencies in the prescribed frequency band. A local coordinate system (X_{Ri1}, Y_{Ri1}, Z_{Ri1}) is defined in each phasing cell identified by the index i. This coordinate system is centered at the cell i and is parallel to the reflectarray coordinate system (X_{R},Y_{R}, Z_{R}). In the present example, a circular reflectarray is chosen, which consists of 973 elements arranged in a 35×35 grid with cell size 11.5 mm×11.5 mm. The reflectarray is fed here by a horn antenna forming the feed 3 with its phase center placed at coordinates x_{f}=−193, y_{f}=0, z_{f}=635 (in mm) with respect to the origin of the reflectarray coordinate system. The reflectarray is designed to operate in dual-linear polarization for transmit and receive operation, where the transmit frequency band is 11.3-12.6 GHz, and the receive frequency band is 13.5-14.5 GHz. The feed horn 3 produces an illumination on the reflectarray edges roughly 10 dB below the illumination level at the reflectarray center in the whole frequency range of interest 11.3-14.5 GHz. The reflectarray is designed to produce a collimated beam in the plane (X_{R}, Z_{R}) at 16.9° from the Z_{R} axis in both linear polarizations.

Once the antenna configuration is defined, the phase distribution of the reflected field required to produce the collimated beam in both linear polarizations is calculated. In the example, the phasing cell structure of the first embodiment shown in FIG. 4 has been chosen wherein eight dipoles per unit cell are employed, four dipoles for each polarization. The required phase distribution on the reflectarray in one linear polarization is increased 180 degrees with respect the phase of the other polarization since this leads to dipole sizes that are different in each polarization, making it easier the accommodation of the eight dipoles in each phasing cell. The lengths of the dipoles are adjusted, element by element, to obtain the phase distributions for each linear polarization, said vertical for the tangential electric field incident on the reflectarray in the direction of X_{R} axis and horizontal for the tangential electric field incident on the reflectarray in the direction of Y_{R} axis. In order to determine the lengths of the dipoles in each cell, a zero finding routine that calls iteratively an analysis routine is used. The zero finding routine iteratively adjusts the lengths of the dipoles until the required phase is obtained for each polarization. The analysis routine for each cell is based on the local periodicity assumption, i.e. it assumes the phasing cell is surrounded by an infinite periodic environment. This routine is a full-wave routine that is based on the well-known Method of Moments in the spectral domain with multilayered Green's functions. By using this routine, the effects of mutual coupling produced by the printed dipoles in the neighbour cells are accounted for provided the lengths of the dipoles vary smoothly from one cell to the next. This local periodicity approach provides accurate results in the prediction of the co-polar and cross-polar radiation pattern of the antenna. The described procedure makes it possible to determine the lengths of the two sets of dipoles in all the cells of the reflectarray antenna.

In a third step 408, for each reflectarray element i or cell i the lengths of the four dipoles in each direction are simultaneously optimized to meet the required phase at several frequencies in the working frequency bands. Starting from the dimensions obtained in the previous second step 406, a new adjustment of the lengths of the conductive dipoles is carried out by using an optimization routine, which iteratively calls the analysis routine. In this step, the lengths of the four dipoles for each polarization are adjusted simultaneously in order to meet the phase specifications defined for several frequencies.

Once the lengths of the dipoles have been adjusted for each polarization, an additional fourth step 410 can be applied optionally, which consists of introducing slight rotation angles in the dipoles as shown for example in FIG. 8 in order to minimize the cross-polar component of the reflected electric field in both polarizations. These rotations for cross-polarization reduction have not been considered in the particular example presented for the first embodiment of the invention shown in FIG. 4.

In a fifth step 412, once the dipole lengths and the dipoles rotation angles are defined for all the reflectarray cells, the reflectarray is manufactured. The photo-etching masks for each reflectarray metallization level are generated from a file with the dipoles lengths and rotation angles for each cell, according to values obtained in the design stages 404, 406, 408, 410. For the manufacturing of the reflectarray, the conventional photo-etching techniques used in the production of printed circuits can be employed, and the different layers are bonded by using conventional curing processes.

FIGS. 13A and 13B show the masks obtained for the two metallization levels in the present example.

FIGS. 14A to 14D show the radiation patterns obtained for the reflectarray antenna of the example in the azimuth and elevation planes for the two linear polarizations at the extremes of the frequency range of interest 11.3 and 14.5 GHz. A gain variation lower than 2 dB is observed in the whole frequency band for both polarizations, and the maximum cross-polarization components are at least 31 dB below the co-polarization components for both polarizations. It should be noted that additional cross-polarization reduction could be achieved by slight rotations of the dipoles as described in FIG. 8.

The FIG. 15 shows the simulated values of the antenna gain and the maximum cross-polarization in the whole frequency range of interest 11.3-14.5 GHz. The small gain variations and the low cross-polarization levels show that the element made of two sets of parallel dipoles simultaneously provides wideband and low cross-polarization performance.

According to FIG. 16 and more generally, a method for designing and manufacturing a wideband reflectarray antenna for dual-polarization applications according to the invention comprises a set 602 of steps 604, 606, 608, 610 and 612.

In a first step 604, a wideband reflectarray antenna configuration is provided that defines a reflectarray coordinate system (X_{R},Y_{R},Z_{R}) and a primary feed configured to radiate two orthogonal polarized fields that illuminate the phasing cells of the reflectarray, each phasing cell comprising:

a conductive ground plane;

at least two dielectric layers;

a third set of parallel dipoles oriented along one of the coordinate axis on the surface of the reflectarray (X_{R} or Y_{R}), comprising at least two conductive dipoles printed on a first surface named A of one of the dielectric layers at a prefixed distance from the ground plane (h_{A}), and at least one additional parallel dipole printed on a second surface named B of one of the dielectric layers at a prefixed distance from the ground plane (h_{B}), so that the center of the set of dipoles on A and the center of the dipole (or dipoles) on B are aligned in a third direction perpendicular to the layers;

a fourth set of parallel dipoles oriented at an angle equal to 90° with respect to the third first set of dipoles, and placed with its center shifted half a period (Px/2, Py/2) with respect to the center of the third set of dipoles, the fourth set of dipoles consisting of at least two parallel dipoles printed on the second surface B and at least one additional parallel dipole printed on the first surface A, so that the center of one dipole on the first surface A and the center of the set of dipoles on the second surface B are aligned in the direction perpendicular to the layers.

In a second step 606, the electric field radiated by the feed in each polarization is decomposed that impinges on each phasing cell of the reflectarray in two components, one called X-polarization with the main component on the coordinate plane (X_{R},Z_{R}) and the other called Y-polarization with the electric field directed along the direction of the Y_{R} axis, and the phase-shift is defined that should be introduced by each phasing cell for the two polarizations of the electric field incident on the phasing cells (X-pol and Y-pol) at several frequencies, so that the electromagnetic field coming from the feed is reflected forming a prescribed collimated or shaped beam in both orthogonal polarizations at the prescribed design frequencies.

In a third step 608, for each phasing cell the lengths of all the parallel dipoles, printed on the surfaces A and B which are parallel to the coordinate axis X_{R}, are determined by using an optimization routine that iteratively calls an analysis routine to adjust the lengths of the at least four parallel dipoles that provides the required phase-shift obtained in step 606 at different frequencies, in order to obtain a broadband performance for the polarization of the reflected electric field with the major component in the coordinate plane (X_{R}, Z_{R}).

In a fourth step 610, for each phasing cell the lengths of all the parallel dipoles, printed on the surfaces A and B which are parallel to the coordinate axis Y_{R}, are determined by using an optimization routine that iteratively calls an analysis routine to adjust the lengths of the at least four parallel dipoles that provides the required phase-shift obtained in step 606 at different frequencies, with a view to obtaining a broadband performance for the polarization of the reflected electric field with the major component in the direction of the coordinate axis Y_{R}.

In the fifth step 612, obtaining the photo-etching masks from the dimensions and positions of all the dipoles in each phasing cell, manufacturing the dielectric layer or the dielectric layers with printed dipoles, bonding the different layers to form the reflectarray panel and assembling the reflectarray and the feed by means of a supporting structure.

In yet another preferred embodiment, after calculating the lengths of the printed dipoles in each phasing cell i for both polarizations in steps 606 and 608 with the two phase units of parallel dipoles oriented along the coordinate axes X_{R} and Y_{R}, a small adjustment of the rotation angles αₓᵢ and α_{yi} of the dipoles around the axes Z_{Ri1} and Z_{Ri2} is carried out by using an optimization routine that calls iteratively an analysis routine to adjust the angles (αₓᵢ, α_{yi}) for the parallel dipoles associated to each polarization (X-pol and Y-pol) in order to simultaneously minimize the cross-polar components of the two polarizations at the prescribed design frequencies. The values of the rotation angles αₓᵢ and α_{yi} are comprised between −10 degrees and +10 degrees.

As a variant, each dipole of each phasing cell is disposed in a previously calculated orientation with respect to the phasing cell so as to reduce the cross-polarization in both orthogonal polarizations, said orientation being dependent upon the particular phasing cell considered.

It should be noted that the reflectarray element or phasing cell of the invention is a low cross-polarization element since there is no physical contact between the two sets of parallel dipoles that are adjusted to provide the required phase shift for the two components of the reflected field (one along the Y_{R} axis and one contained in the coordinate plane (X_{R},Z_{R})). This fact does not occur in the conventional reflectarray elements proposed for dual-polarization applications such as rectangular patches, crossed dipoles, cross loops and rectangular loops. Additional cross-polarization reduction can be achieved by rotating the dipoles in each phasing cell as suggested in the third and fourth preferred embodiments of the invention. Also, since different dipoles are employed to provide the required phase shift for each component of the reflected electric field, the dimensions and angles of orientation of the dipoles can be independently adjusted when generating the radiation pattern of each of the two components, which is not possible with other reflectarray elements previously employed.

It should be noted that the wideband reflectarray antenna for dual-polarization described here above can be designed and manufactured to radiate a focused beam or a contoured beam to be used in satellite broadcast or telecommunication space missions in transmit and receive bands which are separated more than 20%, the transmit and receive Ku frequency bands which are separated more than 20% being a particular case.

In this invention, a wideband reflectarray antenna comprising a set of phasing cells arranged in a periodic rectangular lattice is proposed to operate in dual-linear or dual-circular polarization. The phases of the two linearly polarized components of the reflected electric field are independently adjusted at several frequencies by varying the lengths of two orthogonal or quasi-orthogonal sets of parallel dipoles printed on two different surfaces of a multilayered substrate above a ground plane. The dipoles used to control the phase of one of the components of the reflected field are oriented at an angle of 90° or close to 90° with respect to the dipoles used to control the other component. Also, the center of the former dipoles is shifted half a periodic cell from the center of the latter dipoles, which makes it possible to distribute at least four dipoles for each polarization on just two surfaces of a grounded multilayered substrate.

Two main advantages arise from the reflectarray element consisting of two sets of orthogonal or quasi-orthogonal parallel dipoles that are shifted half a period. On the one hand, these dipoles can be printed at both sides of one single layer as it happens with the element made of two orthogonal sets of edge coupled parallel dipoles (FIG. 2). This possibility reduces the number of layers of the element with respect to the number of layers previously used in multilayered elements containing stacked rectangular patches, which leads to a reduction of the complexity and cost of manufacturing. On the other hand, the reflectarray element of this invention not only contains edge-coupled parallel dipoles but also contains stacked dipoles for each polarization, and therefore, it has a more linear phase variation with dimensions, a wider range of phase variation, and a wider bandwidth than those of the element with edge coupled parallel dipoles. In fact, the bandwidth of the novel reflectarray element can be made comparable to the bandwidth of the elements made of stacked rectangular patches that have been successfully used in the design of DBS (Direct Broadcast Satellite) antennas for dual-polarization dual frequency (transmit-receive) operation in Ku-band.

This invention can be applied to reflector antennas in satellite communications, with significant advantages compared to conventional parabolic or shaped reflectors, or other reflectarray antennas available in the prior state of the art. Compared to previous reflectarray antennas, the present invention allows to fulfil the stringent requirements in bandwidth and cross-polarization for dual-polarization antennas in Direct Broadcast and Telecommunications Satellites, keeping the advantages of a flat panel and the simplicity of manufacturing. Because of the planar characteristic, it can be built in several pieces to be folded and later deployed, this being of great use in applications in which large reflectors are required. Owing to the fact that it is a planar reflector with the possibility of redirecting the beam, the reflector surface can be fitted to existing structures, such as structural planes in communication satellites. It can be used as a dual polarization reflector with an isolation level between polarizations better than those obtained with conventional reflectors.

The present invention can be built by using space qualified materials and a technology already developed in space applications for the manufacture of dichroic subreflectors. Therefore, this type of reflectarray with parallel dipoles for dual polarization in two staked dielectric layers is very suitable for a significant range of applications in the space industry as an alternative to the different types of onboard shaped reflectors in satellites, such as carbon fibre reflectors, dual-gridded reflectors or metallic mesh reflectors.

1. A wideband reflectarray antenna for dual-polarization applications, comprising a feed that radiates two orthogonal polarized electromagnetic fields and an array of phasing cells arranged in a rectangular lattice of period px*py and forming a reflectarray that reflects the electromagnetic energy received from the feed, each phasing cell comprising:
a conductive ground plane, at least two superimposed dielectric layers,
a first set of conductive dipoles printed on a first planar surface A of a first dielectric layer among the at least two superimposed dielectric layers,
and a second set of conductive dipoles printed on a second planar surface B facing remotely the first planar surface A and belonging to the first dielectric layer or to a second layer of the at least two superimposed dielectric layers, wherein
the first set of each phasing cell comprises a third set of at least two parallel dipoles oriented according to a first direction D1 with one dipole thereof centered at the phasing cell and at least one additional dipole, oriented according to a second direction D2 forming an angle β with the first direction of 90° or close to 90°, and placed with its center shifted half a period (pₓ/2,p_{y}/2) with respect to the center of the third set of dipoles, and all the dipoles of the first set are printed on the same first surface A at a prefixed distance from the ground plane;
the second set of each phasing cell comprises a fourth set of at least two parallel dipoles oriented according to the second direction D2 with one dipole, placed with its center shifted half a period (pₓ/2,p_{y}/2) with respect to the center of the third set of dipoles and at least one additional dipole oriented according to the first direction D1 and placed with its center aligned with the center of the third set of dipoles, and all the dipoles of the second set are printed on the same second surface B at a prefixed distance (he) from the ground plane;
the center of the third set and the center of at least one additional dipole are aligned along a third direction perpendicular to the layers, as well as the center of the fourth set and the center of at least one additional dipole are aligned along the third direction;
the lengths of the parallel dipoles oriented along the first direction D1 are simultaneously adjusted to provide a predetermined phase-shift at a finite number of predetermined frequencies in order to obtain a broadband performance for a first polarization of an incident electric field having its major component in the first direction, while the lengths of the parallel dipoles oriented along the second direction D2 are simultaneously adjusted to provide the required phase-shift at a finite number predetermined frequencies in order to obtain a broadband performance for a second polarization of the incident electric field orthogonal to the first polarization, which has its major component in the second direction D2.

2. The wideband reflectarray antenna for dual-polarization applications of claim 1, wherein
the third set of each phasing cell comprises at least three parallel dipoles oriented according to the first direction D1 with one dipole centered at the phasing cell; and
the fourth set of each phasing cell comprises at least three parallel dipoles oriented according to the second direction D2 with one placed with its center shifted half a period (pₓ/2,p_{y}/2) with respect to the center of the third set of dipoles.

3. The wideband reflectarray antenna for dual-polarization applications of claim 1, wherein
each dipole of each phasing cell is disposed in a previously calculated orientation with respect to the phasing cell so as to reduce the cross-polarization in both orthogonal polarizations, said orientation being dependent upon the particular phasing cell considered.

4. The wideband reflectarray antenna for dual-polarization applications of claim 1, wherein
the parallel dipoles of each phasing cell are disposed in a previously same calculated orientation with respect to the phasing cell so as to reduce the cross-polarization in both orthogonal polarizations, said orientation being dependent upon the particular phasing cell considered.

5. The wideband reflectarray antenna for dual-polarization applications of claim 1, wherein the reflectarray comprises the dielectric layer or dielectric layers where the dipoles are printed.

6. The wideband reflectarray antenna for dual-polarization applications of claim 5, wherein
the reflectarray further comprises additional dielectric layers such as bonding layers, additional separators, or one dielectric layer placed above the first surface A to protect the printed dipoles.

7. The wideband reflectarray antenna for dual-polarization applications of claim 1, comprising a multilayered antenna substrate that has either honeycomb separators or air separation that is fixed by means of periodically placed spacers.

8. The wideband reflectarray antenna for dual-polarization applications of claim 1, wherein
a reflectarray coordinate system (X_{R},Y_{R},Z_{R}) is considered and the Z_{R} axis is chosen perpendicular to the reflectarray;
the phase-center of the feed is placed on the coordinate plane (X_{R},Z_{R});
in each phasing cell, the third set of at least two parallel dipoles on the first surface A and the at least one dipole on the second surface B oriented according to the first axis are parallel to the X_{R} axis while the fourth set of at least two parallel dipoles on the second surface B and the at least one dipole on the first surface A oriented according to the second axis are parallel to the Y_{R} axis.

9. The wideband reflectarray antenna for dual-polarization applications of claim 1, wherein
a reflectarray coordinate system (X_{R},Y_{R},Z_{R}) is considered and the Z_{R} axis is chosen perpendicular to the reflectarray plane;
the phase-center of the feed is placed on the coordinate plane (X_{R},Z_{R});
in each phasing cell, the third set of at least two parallel dipoles on the first surface A and the at least one dipole on the second surface B oriented according to the first axis are parallel to the Y_{R} axis while the fourth set of at least two parallel dipoles on the second surface B and the at least one dipole on the second surface A oriented according to the second axis are parallel to the X_{R} axis.

10. The wideband reflectarray antenna for dual-polarization applications of claim 1, wherein
a reflectarray coordinate system (X_{R},Y_{R},Z_{R}) is considered and the Z_{R} axis is chosen perpendicular to the reflectarray plane;
the phase-center of the feed is placed on the coordinate plane (X_{R},Z_{R});
a first local coordinate system (X_{Ri1},Y_{Ri1},Z_{Ri1}) is considered in each phasing cell i which is centered at the cell i and is parallel to the reflectarray coordinate system (X_{R},Y_{R},Z_{R}),
a second local coordinate system (X_{Ri2},Y_{Ri2},Z_{Ri2}) is considered in each phasing cell i which is centered at the corner of the phasing cell i where the at least one dipole on the first surface A oriented according to the second direction is placed and is parallel to the reflectarray coordinate system (X_{R},Y_{R},Z_{R});
in each phasing cell i, the third set of at least two parallel dipoles on the first surface A and the at least one dipole on the second surface oriented to the first axis are rotated by a first angle αₓᵢ with respect to the axis X_{Ri1} around the axis Z_{Ri1} while the fourth set of at least two parallel dipoles on the second surface B and the at least one dipole on the first surface A oriented according to the second direction are rotated with respect to the axis Y_{Ri2} by a second angle α_{yi} around the axis Z_{Ri2}, the said angles αₓᵢ and α_{yi} being previously calculated in each cell i to minimise the cross-polarization for both orthogonal polarizations of the incident field.

11. The wideband reflectarray antenna for dual-polarization applications of claim 1, wherein
a reflectarray coordinate system (X_{R},Y_{R},Z_{R}) is considered and the Z axis is chosen perpendicular to the reflectarray plane,
the phase-center of the feed is placed on the coordinate plane (X_{R},Z_{R}); a first local coordinate system (X_{Ri1},Y_{Ri1},Z_{Ri1}) is considered in each phasing cell i which is centered at the cell and is parallel to the reflectarray coordinate system (X_{R},Y_{R},Z_{R});
a second local coordinate system (X_{Ri2},Y_{Ri2},Z_{Ri2}) is considered in each phasing cell i which is centered at the corner of the cell where the at least one dipole on the first surface A oriented according to the second direction D2 is placed and is parallel to the reflectarray coordinate system (X_{R},Y_{R},Z_{R});
in each phasing cell i, the third set of at least two parallel dipoles on the first surface A and the at least one dipole on the second surface B are rotated by a first angle α_{yi} with respect to the axis Y_{Ri1} around the axis Z_{Ri1} while the fourth set of at least two parallel dipoles on the second surface B and the at least one dipole on the first surface A oriented according to the second direction D2 are rotated by a second angle αₓᵢ with respect to the axis X_{Ri2} around the axis Z_{Ri2}, the said angles α_{yi} and αₓᵢ being previously calculated in each cell i to minimise the cross-polarization for both orthogonal polarizations of the incident field.

12. The wideband reflectarray antenna for dual linear polarization of claim 1, wherein
a reflectarray coordinate system (X_{R},Y_{R},Z_{R}) is considered and the Z_{R} axis is chosen perpendicular to the reflectarray plane,
the feed placed at the coordinate plane (X_{R},Z_{R}) radiates two orthogonal linear polarized fields, one with the main component of the electric field in the direction of the Y_{R} axis, and the other with the main component of electric field orthogonal to the Y_{R} axis and contained in the coordinate plane (X_{R},Z_{R}), the lengths of the dipoles in each phasing cell are simultaneously adjusted to produce a reflected electric field polarized in the Y_{R} direction with a constant phase shift with respect to the phase of the reflected electric field contained in the coordinated plane (X_{R},Z_{R}) at the prescribed design frequencies, so that the same radiation patterns are generated for the two orthogonal linear polarizations.

13. The wideband reflectarray antenna for dual linear polarization of claim 1, wherein
a reflectarray coordinate system (X_{R},Y_{R},Z_{R}) is considered and the Z_{R} axis is chosen perpendicular to the reflectarray plane;
the feed placed at the coordinate plane (X_{R},Z_{R}) radiates two orthogonal linear polarized fields, one with the main component of the electric field in the direction of the Y_{R} axis, and the other with the main component of the electric field orthogonal to the Y_{R} axis and contained in the coordinate plane (X_{R},Z_{R}); the lengths of the dipoles in each phasing cell are simultaneously adjusted to produce a prefixed radiation pattern for the electric field polarized in the direction of Y_{R} and a different radiation pattern for the orthogonal electric field contained in the coordinate plane (X_{R},Z_{R}).

14. wideband reflectarray antenna for dual circular polarization of claim 1, wherein a reflectarray coordinate system (X_{R},Y_{R},Z_{R}) is considered and the Z_{R} axis is chosen perpendicular to the reflectarray plane, wherein the feed radiates two orthogonal circular polarized fields, one with Right Hand Circular Polarization (RHCP), and the other with Left Hand Circular Polarization (LHCP), and wherein the lengths of the dipoles in each phasing cell are simultaneously adjusted to produce the same phase distribution for the reflected electric field polarized in the direction of Y_{R} axis and for the reflected electric field contained in the coordinated plane of (X_{R},Z_{R}) at the prescribed design frequencies.

15. The wideband reflectarray antenna for dual circular polarization of claim 1, wherein
a reflectarray coordinate system (X_{R},Y_{R},Z_{R}) is considered and the Z_{R} axis is chosen perpendicular to the reflectarray plane;
the feed placed in the coordinate plane (X_{R},Z_{R}) radiates two orthogonal linear polarized electromagnetic fields, with the electromagnetic fields slanted +45 degrees and −45 degrees with respect to the coordinate plane (X_{R},Z_{R}), respectively; and
the lengths of the dipoles in each phasing cell are simultaneously adjusted to produce a reflected electric field polarized in the direction of Y_{R} with a phase shifted +90 degrees or −90 degrees with respect to the phase of the reflected electric field contained in the coordinate plane of (X_{R},Z_{R}) at the prescribed design frequencies, so that the dual linear polarization radiated by the feed is converted into dual circular polarization radiated by the reflectarray antenna.

16. The wideband reflectarray antenna for dual-polarization applications of claim 1, wherein
a focused beam or contoured beam is radiated to be used in satellite broadcast or telecommunication space missions in transmit and receive frequency bands which are separated more than 20%, in particular transmit and receive Ku frequency bands which are separated more than 20%.

17. A method for providing a wideband reflectarray antenna for dual-polarization applications comprising:
providing a reflectarray with a reflectarray coordinate system (X_{R},Y_{R},Z_{R}), and a feed configured to radiate two orthogonal polarized fields that illuminate the phasing cells of the reflectarray, each phasing cell comprising:
a conductive ground plane;
at least two dielectric layers;
a third set of parallel dipoles oriented along a first direction aligned with one of the coordinate axis on the surface of the reflectarray (X_{R} or Y_{R}), comprising at least two dipoles printed on a first surface A of one of the dielectric layers at a prefixed distance from the ground plane, and at least one additional parallel dipole oriented along a first direction and printed on a second surface B of one of the dielectric layers at a prefixed distance from the ground plane, so that the center of the third set of dipoles on the first surface A and the center of the dipole or dipoles on the surface B are aligned in a direction perpendicular to the layers;
a fourth set of parallel dipoles oriented at an angle of 90° with respect to the third set of dipoles, and placed with its center shifted half a period (Px/2, Py/2) with respect to the center of the third set of dipoles, the fourth set of dipoles consisting of at least two parallel dipoles printed on the second surface B and at least one additional parallel dipole printed on the first surface A, so that the center of the dipole or dipoles on the first surface A and the center of the fourth set of dipoles on the second surface B are aligned in the direction perpendicular to the layers;
decomposing the electric field radiated by the feed in each polarization that impinges on each phasing cell of the reflectarray in two components, one called X-polarization with the main component on the coordinate plane (X_{R},Z_{R}) and the other called Y-polarization with the electric field directed along the direction of the Y_{R} axis, and defining the phase-shift that should be introduced by each phasing cell for the two polarizations of the electric field incident on the phasing cells (X-pol and Y-pol) at several frequencies, so that the electromagnetic field coming from the feed is reflected forming a prescribed collimated or shaped beam in both orthogonal polarizations at the prescribed design frequencies;
the method further comprising:
determining for each phasing cell the lengths of all the parallel dipoles printed on the first surface A and second surface B which are parallel to the coordinate axis X_{R}, by using a first optimization routine that iteratively calls a second analysis routine to adjust the lengths of the at least three parallel dipoles that provides the required phase-shift obtained in step at different frequencies, in order to obtain a broadband performance for the polarization of the reflected electric field with the major component in the coordinate plane (X_{R}, Z_{R});
determining for each phasing cell the lengths of all the parallel dipoles printed on the surfaces A and B which are parallel to the coordinate axis Y_{R}, by using an optimization routine that iteratively calls an analysis routine to adjust the lengths of the at least four parallel dipoles that provides the required phase-shift obtained in step at different frequencies, in order to obtain a broadband performance for the polarization of the reflected electric field with the major component in the direction of the coordinate axis Y_{R};
obtaining the photo-etching masks from the dimensions and positions of all the dipoles in each phasing cell i, manufacturing the dielectric layer (or dielectric layers) with printed dipoles, bonding the different layers to form the reflectarray panel and assembling the reflectarray and the feed by means of a supporting structure.

18. The method of claim 17, wherein after calculating the lengths of the printed dipoles in each phasing cell i for both polarizations with the two sets of parallel dipoles oriented along the coordinate axes X_{R} and Y_{R}, a small adjustment of the rotation angles αₓᵢ and α_{yi} of the dipoles around the axes Z_{Ri1} and Z_{Ri2} is carried out by using an optimization routine that calls iteratively an analysis routine to adjust the angles (α_{Xi}, α_{Yi}) for the parallel dipoles associated to each polarization (X-pol and Y-pol) in order to simultaneously minimize the cross-polar components of the two polarizations at the prescribed design frequencies, the values of the rotation angles αₓᵢ and α_{yi} being comprised between −10 degrees and +10 degrees.
